(19) United States
(12) Patent Application Publication
(10) Pub. No.: US 2015/0064984 A1
(43) Pub. Date: Mar. 5, 2015

(54) ELECTRONIC COMPONENT SOCKET

(71) Applicant: ALPS ELECTRIC CO., LTD., Tokyo (JP)

(72) Inventors: Shigetomo CHIBA, Tokyo (JP); Takeshi MURAYAMA, Tokyo (JP); Hiroyuki TAKAOKA, Tokyo (JP); Takeki UOZUMI, Tokyo (JP); Nobuyuki OKUDA, Tokyo (JP)

(21) Appl. No.: 14/463,918

(22) Filed: Aug. 20, 2014

(30) Foreign Application Priority Data
Aug. 29, 2013 (JP) 2013-177851
Apr. 3, 2014 (JP) 2014-076919

(51) Int. Cl. H01R 13/24; H01R 13/6588

(52) U.S. Cl. CPC H01R 13/2407; H01R 13/6588
USPC 439/700

(57) ABSTRACT

An electronic component socket includes a shield plate set forming an opening portion, a movement member including a conductive member having a contact portion capable of contacting an electrode terminal of an electronic component, an elastic member which is electrically connectable to a wiring substrate, and includes a biasing portion having a biasing force and a base portion fixing the biasing portion. The movement member is disposed to move vertically above the elastic member in the opening portion, and the biasing portion elastically contacts the movement member. The shield plate set includes a protrusion protruding in the opening portion, the movement member includes a concave portion which engages with the protrusion, the conductive member includes an inclined surface portion which extends so as to be inclined on an opposite side of the concave portion, and the biasing portion of the elastic member elastically contacts the inclined surface portion.

### CLAIM OF PRIORITY

This application contains subject matter related to and claims the benefit of Japanese Patent Application Nos. 2013-177851 filed on Aug. 29, 2013 and 2014-076919 filed on Apr. 3, 2014, the entire contents of which are incorporated herein by reference.

### BACKGROUND OF THE DISCLOSURE

1. Field of the Disclosure

The present disclosure relates to an electronic component socket, and particularly, to an electronic component socket in which a removal preventing structure can be processed without being limited by a size of a conductive member and desired removal prevention strength can be obtained.

2. Description of the Related Art

In recent years, the number of instances where an electric connection between an electronic device and an electronic component used in the electronic device, particularly, an electronic component having a plurality of connection terminals is performed via an electronic component socket has increased. The electronic component socket is electrically connected to the electric device via soldering, conductive adhesive, or the like, and the electronic component is locked to the electronic component socket by press fitting, engagement such as snap-in, or the like, and is electrically connected to the electronic component socket by press welding. Accordingly, attachment of the electronic component to the electronic device is easily performed, and thus, a defect such as deformation of the connection terminal when the electronic component is attached does not easily occur.

As the electronic component socket, an electronic component socket disclosed in Japanese Unexamined Patent Application Publication No. 2008-021639 described below is known.

Hereinafter, with reference to FIG. 21, an electronic component socket 900 in Japanese Unexamined Patent Application Publication No. 2008-021639 will be described. FIG. 21 is a cross-sectional view showing a structure of a contact 940 included in the electronic component socket 900 disclosed in Japanese Unexamined Patent Application Publication No. 2008-021639.

As shown in FIG. 21, the electronic component socket 900 disclosed in Japanese Unexamined Patent Application Publication No. 2008-021639 includes an electronic component which can correspond so as to be connected, for example, the contact 940 which is a conductive member which is electrically connected to an integrated circuit package 980. The contact 940 includes a support 941. Moreover, the contact includes a first spring member 943 which extends the front aslant upward from the upper end of the support 941 and has a first contact portion 944 contacting an integrated circuit package 980 at a tip portion, and a second spring member 945 having a first contact member 946 which is bent from the first contact portion 944, extends rearward aslant downward, and has a first contact member 946 at a tip portion. Moreover, the contact includes a third spring member 947 which extends frontward aslant downward from the lower end of the support 941, has a second contact portion 948 contacting a print wiring board 960 at a tip portion, and forms a pair with the first spring member 943 interposing the support 941, and a fourth spring member 949 which is bent from the second contact portion 948, extends rearward aslant upward, and has a second contact member 951 which is disposed to contact the first contact member 946 at a tip portion. Moreover, the support 941 includes a lock claw 942 which is formed to be raised rearward. The contact 940 is accommodated in a contact accommodation chamber 925, and a locking groove 931 into which the lock claw 942 can be inserted is formed on an inner wall portion of the contact accommodation chamber 925. A second regulation wall 933, which can engage with the lock claw 942, is formed on the upper side of the locking groove 931. In addition, when the contact 940 is accommodated in the contact accommodation chamber 925, the lock claw 942 contacts the wall of the contact accommodation chamber 925. However, since the lock claw 942 has elasticity, the contact 940 can be easily attached to the contact accommodation chamber 925 by snap-in. When the integrated circuit package 980 is not attached to the electronic component socket 900, the contact 940 accommodated in the contact accommodation chamber 925 is pressed upward by its own elastic force, and thus, the lock claw 942 and the second regulation wall 933 of the locking groove 931 elastically contact each other. Accordingly, even when the integrated circuit package 980 is not attached to the electronic component socket 900, falling-out of the contact 940 can be prevented.

In the future, when a small-sized electronic component or an electronic component in which the number of the connection terminals per a unit area is increased is used, in the electronic component socket 900, the contact 940 and the contact accommodation chamber 925 are required to be smaller. However, if the size of the conductive member such as the contact 940 is decreased, it is difficult to process a removal preventing structure such as the lock claw 942, and there is a problem that a desired removal prevention strength cannot be obtained.

These and other drawbacks exist.

### SUMMARY OF THE DISCLOSURE

Embodiments of the present disclosure provide an electronic component socket in which a removal preventing structure can be processed without being limited by a size of a conductive member and desired removal prevention strength can be obtained.

According to an example embodiment, an electronic component socket includes: a shield body configured to form an opening portion and have conductivity; a movement member which includes a conductive member having a contact portion capable of contacting an electrode terminal of an electronic component placed above the opening portion; and an elastic member which is configured to be electrically connectable to a wiring of a wiring substrate placed below the opening portion and includes a biasing portion having a biasing force and a base portion fixing the biasing portion. The movement member is disposed to move vertically above the elastic member in the opening portion, and the biasing portion elastically contacts the movement member. The shield body includes a protrusion protruding toward a center of the opening portion in the opening portion. The movement member includes a concave portion which engages with the protrusion. The conductive member includes an inclined surface portion which is formed on an opposite side of the concave portion and extends so as to be close to a side, on which the concave portion is provided, toward a lower side. The biasing portion of the elastic member elastically contacts the inclined surface portion.

According to an example embodiment, in the electronic component socket, the shield body may be formed of a metal plate, and the protrusion may be formed by protrusion-processing the metal plate.

Also, in the electronic component socket, the shield body may be integrally formed and may be formed of a resin molded piece to which metal plating is applied, and the protrusion may be formed by molding.

According to an example embodiment, in the electronic component socket, the shield body may include: a first protrusion which is provided on one side with respect to a first center line bisecting an opening end portion of the opening portion in a plan view and on one side with respect to a second center line orthogonal to the first center line, and protrudes in a center direction of the opening portion; and a second protrusion which is provided on the other side with respect to the first center line and on the other side with respect to the second center line, and protrudes in a direction opposite to the protrusion direction of the first protrusion. The movement member may include: a first concave portion which is provided on one side with respect to the first center line and on one side with respect to the second center line, and engages with the first protrusion; and a second concave portion which is provided on the other side with respect to the first center line and on the other side with respect to the second center line, and engages with the second protrusion. The inclined surface portion of the conductive member may include: a first inclined surface portion which is formed on a rear side of the first concave portion and extends so as to be close to the side, on which the first concave portion is provided, toward a lower side; and a second inclined surface portion which is formed on a rear side of the second concave portion and extends so as to be close to the side, on which the second concave portion is provided, toward a lower side. The biasing portion of the elastic member may include a first elastic contact portion which elastically contacts the first inclined surface portion, and a second elastic contact portion which elastically contacts the second inclined surface portion.

According to an example embodiment, an electronic component socket includes: a shield body configured to form an opening portion and have conductivity; a movement member which includes a conductive member having a contact portion capable of contacting an electrode terminal of an electronic component placed above the opening portion; and an elastic member which is configured to be electrically connectable to a wiring of a wiring substrate placed below the opening portion and includes a biasing portion having a biasing force and a base portion fixing the biasing portion. The movement member is disposed to move vertically above the elastic member in the opening portion, and the biasing portion elastically contacts the movement member. The movement member includes a protrusion protruding toward the shield body. The shield body includes a concave portion which engages with the protrusion in the opening portion. The conductive member includes an inclined surface portion which is formed on a rear side of the protrusion and extends so as to be close to a side, on which the protrusion is provided, toward a lower side. The biasing portion of the elastic member elastically contacts the inclined surface portion.

According to a sixth aspect of the present invention, in the electronic component socket, the shield body may be integrally formed and may be formed of a resin molded piece to which metal plating is applied, and the concave portion may be formed by molding.

According to an example embodiment, in the electronic component socket, the shield body may be formed of a metal plate, and the concave portion may be formed by protrusion-processing the metal plate.

Also, in the electronic component socket, the movement member may include: a first protrusion which is provided on one side with respect to a first center line bisecting an opening end portion of the opening portion in a plan view and on one side with respect to a second center line orthogonal to the first center line, and protrudes toward the shield body; and a second protrusion which is provided on the other side with respect to the first center line and on the other side with respect to the second center line, and protrudes in a direction opposite to the protrusion direction of the first protrusion. The shield body may include: a first concave portion which is provided on one side with respect to the first center line and on one side with respect to the second center line, and engages with the first protrusion; and a second concave portion which is provided on the other side with respect to the first center line and on the other side with respect to the second center line, and engages with the second protrusion. The inclined surface portion of the conductive member may include: a first inclined surface portion which is formed on a rear side of the first protrusion and extends so as to be close to the side, on which the first protrusion is provided, toward a lower side; and a second inclined surface portion which is formed on a rear side of the second protrusion and extends so as to be close to the side, on which the second protrusion is provided, toward a lower side. The biasing portion of the elastic member may include a first elastic contact portion which elastically contacts the first inclined surface portion, and a second elastic contact portion which elastically contacts the second inclined surface portion.

According to the various embodiments, since the protrusion is easily formed compared to a cut-and-raised portion, a reduction in the size can be more easily achieved. In addition, the conductive member included in the movement member includes the inclined surface portion which is formed on the rear side of the concave portion and extends so as to be close to the side on which the concave portion is provided toward the lower portion, and the biasing portion of the elastic member elastically contacts the inclined surface portion from the lower portion. Accordingly, the movement member is biased upward by the elastic force of the biasing portion, and is biased to the direction in which the protrusion is provided. That is, the concave portion is pressed to the protrusion, and thus, engagement between the protrusion and the concave portion is securely performed. Accordingly, a socket electronic component, in which a removal preventing structure can be processed without being limited by a size of the conductive member, and desired removal prevention strength can be obtained, can be provided.

Also, in various embodiments, since the shield body is formed of a metal plate, compared to a case where, for example, the shield body is formed of a plate-shaped member of a synthetic resin material and is subjected to the processing for providing conductivity, the shield body can be easily formed. Moreover, since the protrusion is formed by the protrusion-processing, compared to the cut-and-raised portion, there is an advantageous effect in that the reduction in the size can be easily achieved, damage does not easily occur, and yield can be improved.

According to an example embodiment, the shield body is formed of the resin molded piece which is integrally formed, and thus, compared to when a plurality of parts are formed to be combined, assembly is easily performed. In addition, when metal plating is applied to the surface, it is not necessary to apply the metal plating to each of the plurality of parts, and thus, frequency of the plating can be decreased. In addition, there is an advantageous effect in that the formation of the protrusion can be easily performed by a molding die.

According to an example embodiment, the first protrusion and the first concave portion are provided on one side with respect to the first center line bisecting the opening end portion of the opening portion in a plan view and on one side with respect to the second center line orthogonal to the first center line, the second protrusion and the second concave portion are provided on the other side with respect to the first center line and on the other side with respect to the second center line, and thus, the movement member is engaged at two locations, and falling-out of the movement member does not easily occur. In addition, the first inclined surface portion and the second inclined surface portion are biased in directions opposing each other in a plan view, respectively, and thus, the movement member is rotated along a plane perpendicular to the movement direction. Accordingly, the movement member is not easily inclined with respect to the movement direction, and the engagement between the protrusion and the concave portion is not easily released. That is, the shield body and the movement member engage with each other at two locations, the movement member is not easily inclined with respect to the movement direction, and the engagement between the protrusion and the concave portion is not easily released. Therefore, there is an advantageous effect in that the electronic component socket more easily capable of obtaining desired removal prevention strength can be provided.

According to an example embodiment, since the protrusion is more easily formed compared to a cut-and-raised portion, a reduction in the size can be more easily achieved. In addition, the conductive member included in the movement member includes the inclined surface portion which is formed on the rear side of the protrusion and extends so as to be close to the side on which the protrusion is provided toward the lower portion, and the biasing portion of the elastic member elastically contacts the inclined surface portion from the lower portion. Accordingly, the movement member is biased upward by the elastic force of the biasing portion, and is biased to the direction in which the concave portion is provided. That is, the protrusion is pressed to the concave portion, and thus, engagement between the protrusion and the concave portion is securely performed. Accordingly, an electronic component socket, in which the removal preventing structure can be processed without being limited by a size of the conductive member and desired removal prevention strength can be obtained, can be provided.

According to an example embodiment, the shield body is formed of the resin molded piece which is integrally formed, and thus, compared to when a plurality of parts are formed to be combined, assembly is easily performed. In addition, when metal plating is applied to the surface, it is not necessary to apply the metal plating to each of the plurality of parts, and thus, frequency of the plating can be decreased. In addition, there is an advantageous effect in that the formation of the concave portion can be easily performed by a molding die.

According to an example embodiment, since the shield body is formed of a metal plate, compared to a case where, for example, the shield body is formed of a plate-shaped member of a synthetic resin material and is subjected to the processing for providing conductivity, the shield body can be easily formed. Moreover, since the concave portion is formed by the protrusion-processing, compared to the cut-and-raised portion, there is an advantageous effect in that the reduction in the size can be easily achieved, damage does not easily occur, and yield can be improved.

According to an example embodiment, the conductive member included in the movement member includes the inclined surface portion which is formed on the rear side of the protrusion and extends so as to be close to the side on which the protrusion is provided toward the lower portion, and the biasing portion of the elastic member elastically contacts the inclined surface portion from the lower portion. Accordingly, the movement member is biased upward by the elastic force of the biasing portion, and is biased to the direction in which the concave portion is provided. That is, the protrusion is pressed to the concave portion, and thus, engagement between the protrusion and the concave portion is securely performed. Accordingly, an electronic component socket, in which the removal preventing structure can be processed without being limited by a size of the conductive member and desired removal prevention strength can be obtained, can be provided.

As described above, according to the example embodiments of the present disclosure, an electronic component socket, in which the removal preventing structure can be processed without being limited by a size of the conductive member, and desired removal prevention strength can be obtained, can be provided.

### BRIEF DESCRIPTION OF THE DRAWINGS

FIG. 1 is a perspective view showing a configuration of an electronic component socket in an embodiment of the disclosure;

FIG. 2 is a perspective view showing a configuration of a contact unit in an embodiment of the disclosure;

FIGS. 3A and 3B are views showing a movement member in an embodiment of the disclosure;

FIG. 4 is a perspective view showing a contact bar in an embodiment of the disclosure;

FIG. 5 is a plan view showing a disposition example of a first elastic contact portion and a second elastic contact portion in an embodiment of the disclosure;

FIGS. 6A and 6B are plan views showing a disposition position of the first elastic contact portion and the second elastic contact portion in an embodiment of the disclosure;

FIGS. 7A to 7D are views for an operation explanation of the electronic component socket in an embodiment of the disclosure;

FIGS. 8A and 8B are views showing an engagement state between a protrusion and a concave portion in an embodiment of the disclosure;

FIG. 9 is a schematic view showing a configuration of an electronic component socket in a second embodiment;

FIG. 10 is a schematic view for an operation explanation of the electronic component socket in an embodiment of the disclosure, and is a view showing a state where the socket is pressed downward from the state shown in FIG. 9;

FIGS. 11A and 11B are views showing an electronic component socket in an embodiment of the disclosure, FIG. 11A is an enlarged perspective view showing an outline of the electronic component socket, and FIG. 11B is an enlarged plan view showing a G portion shown in FIG. 11A viewed from a Z1 direction side, and the shape of an opening portion of a shield body shown in FIGS. 11A and 11B is schematically shown to be different from an actual shape;

FIGS. 12A and 12B are views showing a movement member in an embodiment of the disclosure, FIG. 12A is a perspective view showing an outline of the movement member, and FIG. 12B is a perspective view showing the movement member when viewed from a Z2 direction side shown in FIG. 12A;

FIGS. 13A to 13C are views showing an elastic member in an embodiment of the disclosure, FIG. 13A is a perspective view showing an outline of the elastic member, FIG. 13B is a side view showing the elastic member when viewed from a Y2 direction side shown in FIG. 13A, and FIG. 13C is a side view showing the elastic member when viewed from an X2 direction side shown in FIG. 13A;

FIGS. 14A and 14B are views showing a portion of the shield body in an embodiment of the disclosure, FIG. 14A is a perspective view showing a portion of the shield body, and FIG. 14B is an enlarged view showing an H portion shown in FIG. 14A viewed from the Z1 direction side;

FIGS. 15A and 15B are enlarged views showing a J portion shown in FIGS. 14A and 14B, FIG. 15A is an enlarged view showing the J portion viewed from the Z1 direction, and FIG. 15B is an enlarged view showing the J portion viewed from the Z2 direction side;

FIG. 16 is a perspective view showing a cross-section of the opening portion taken along cross-section line K-K shown in FIGS. 15A and 15B, from the Z2 direction side;

FIG. 17 is a schematic view showing a structure of the electronic component socket in an embodiment of the disclosure, and FIG. 17 shows a state where the socket is disposed on a wiring substrate, and contacts an electrode terminal of the electronic component;

FIG. 18 is a plan view showing a state where the elastic member is disposed in the opening portion in an embodiment of the disclosure, from the Z1 direction side shown in FIGS. 11A and 11B;

FIG. 19 is a schematic view showing a structure of the electronic component socket before the movement member in an example embodiment is incorporated;

FIGS. 20A and 20B are views showing a method of inserting the movement member into the opening portion in the an example embodiment, FIG. 20A is a plan view showing a direction of the movement member when the movement member is inserted into the opening portion, and FIG. 20B is a plan view showing the direction of the movement member after the movement member is inserted into the opening portion; and

FIG. 21 is a cross-sectional view showing a structure of a prior art connector included in an electronic component socket disclosed in Japanese Unexamined Patent Application Publication No. 2008-021639.

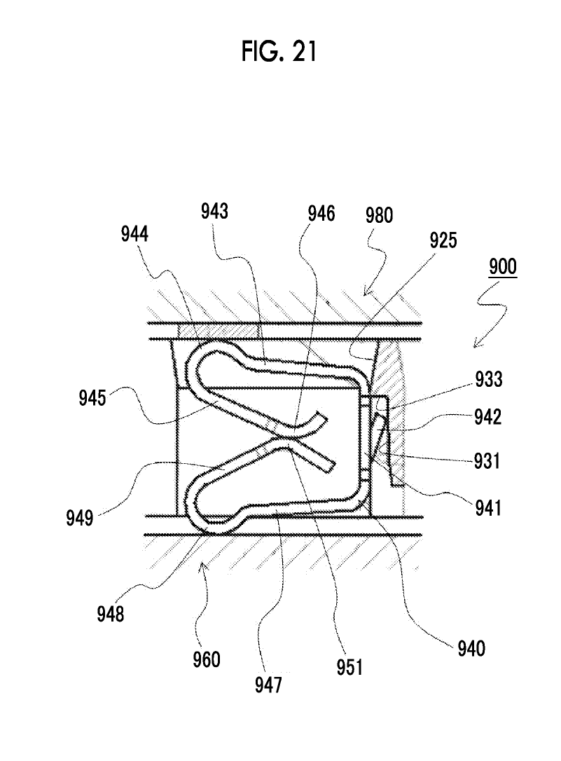

### DETAILED DESCRIPTION OF THE DISCLOSURE

The following description is intended to convey a thorough understanding of the embodiments described by providing a number of specific embodiments and details involving an electronic component socket. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

Hereinafter, an electronic component socket 100 in an example embodiment will be described.

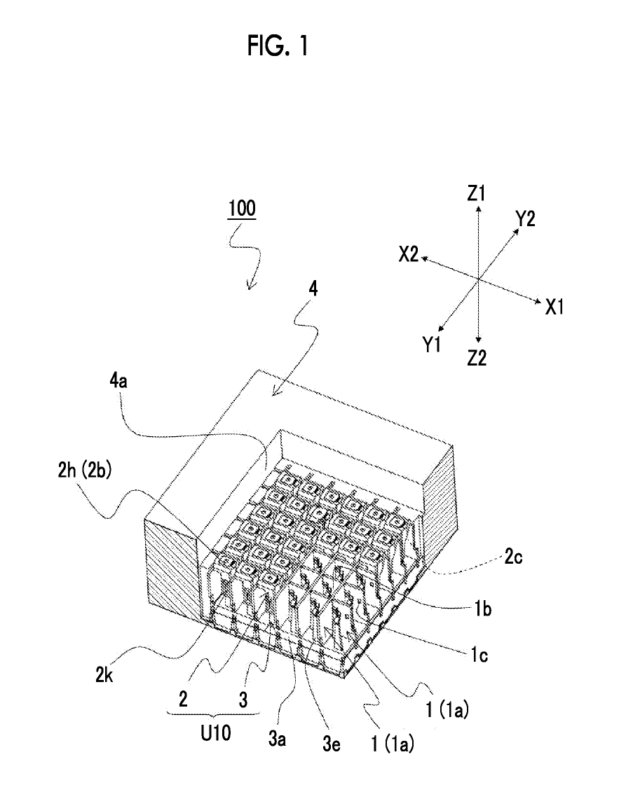

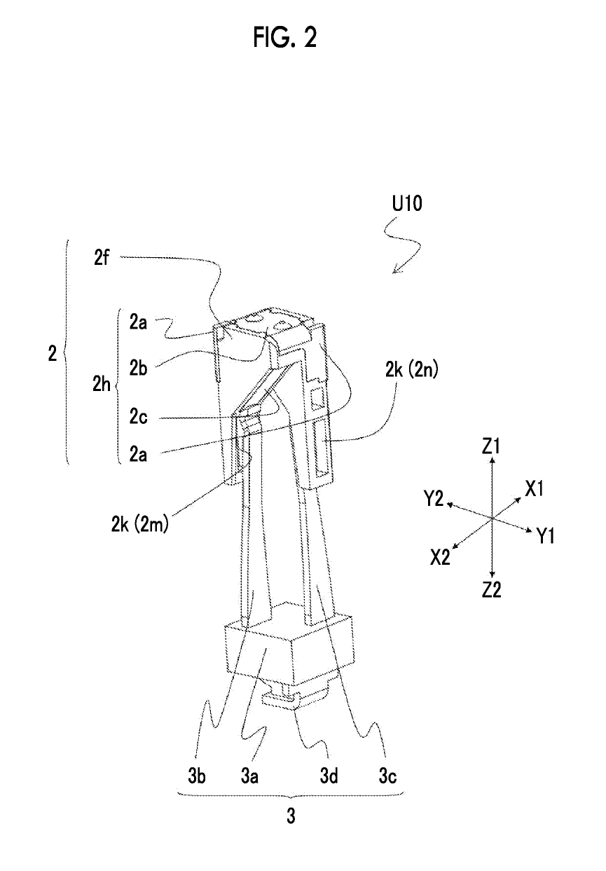

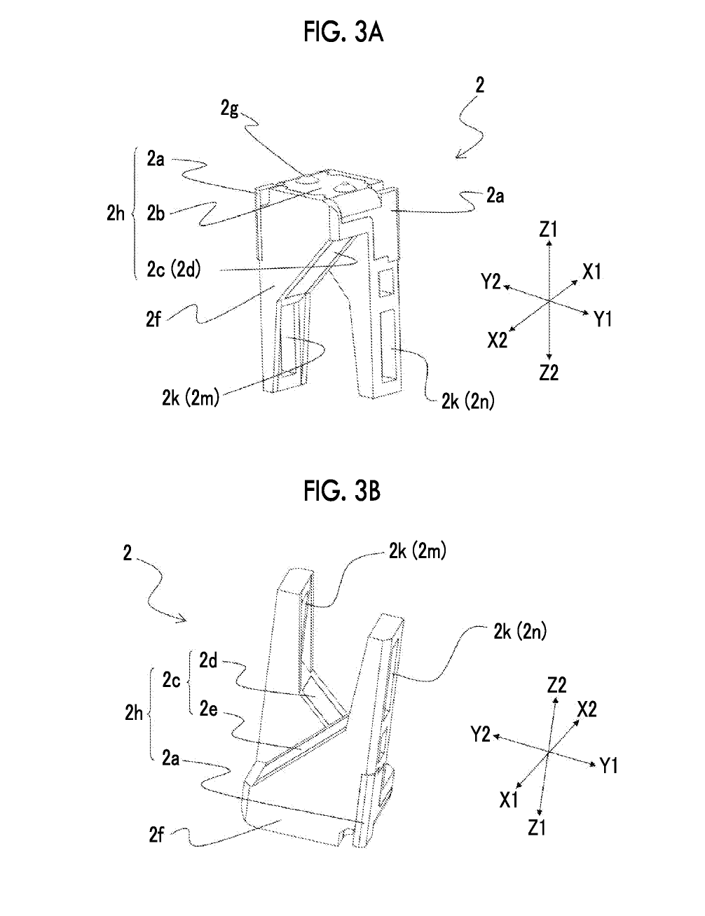

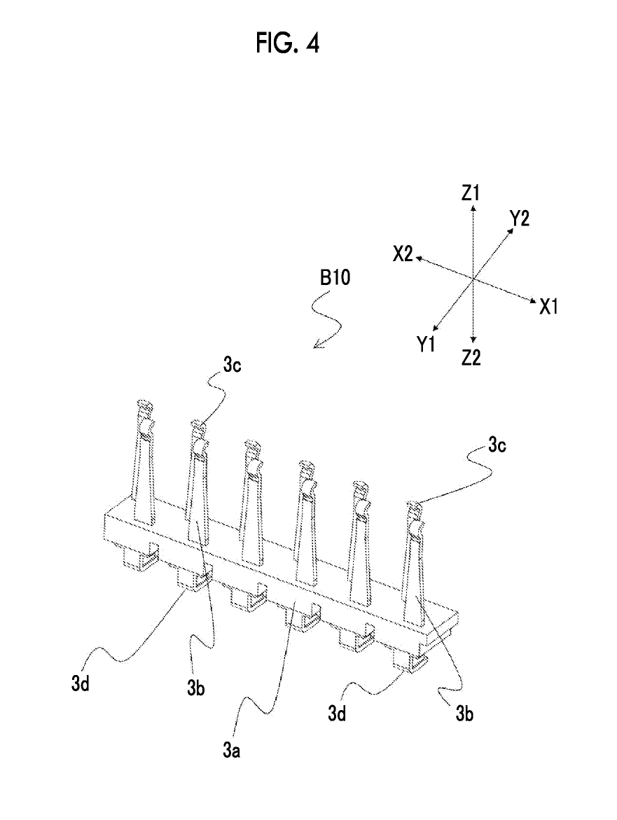

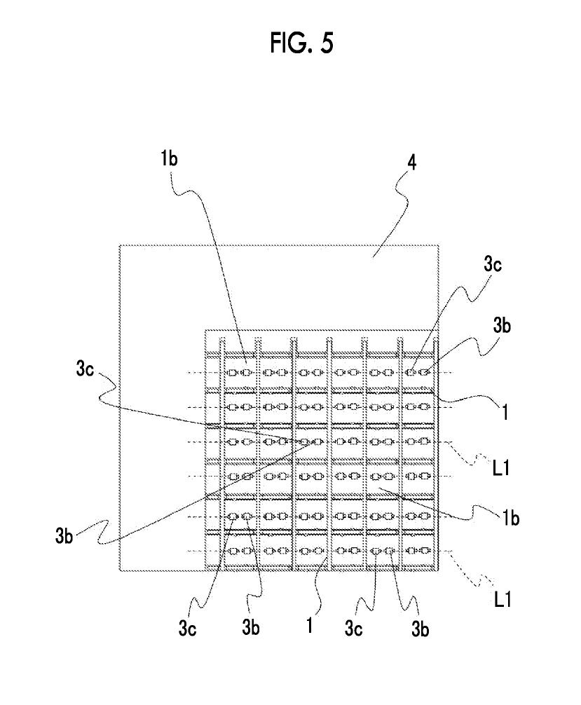

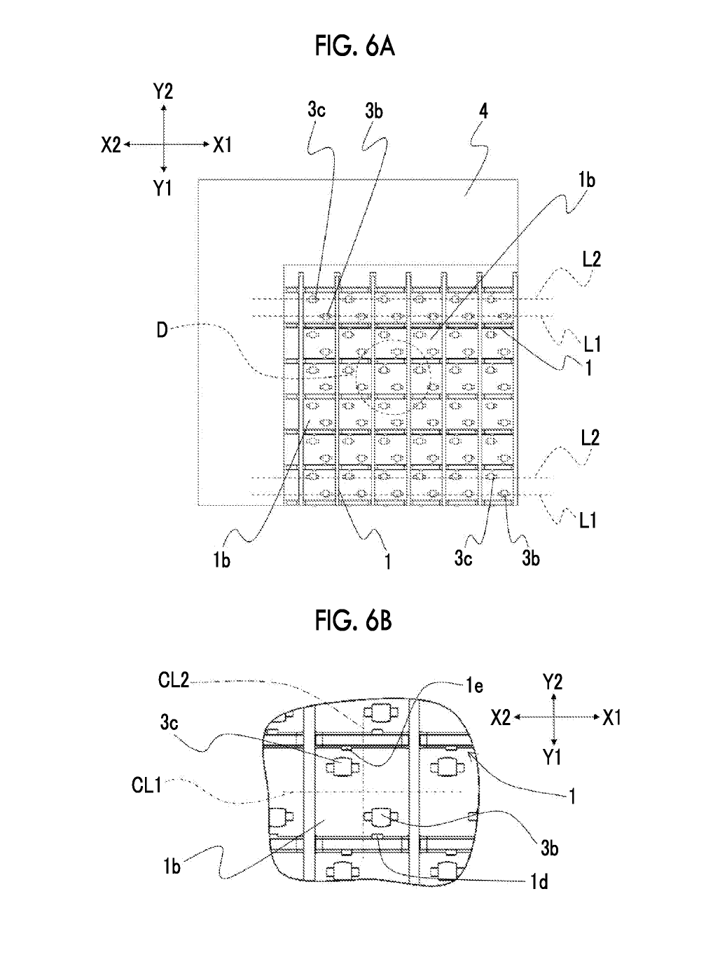

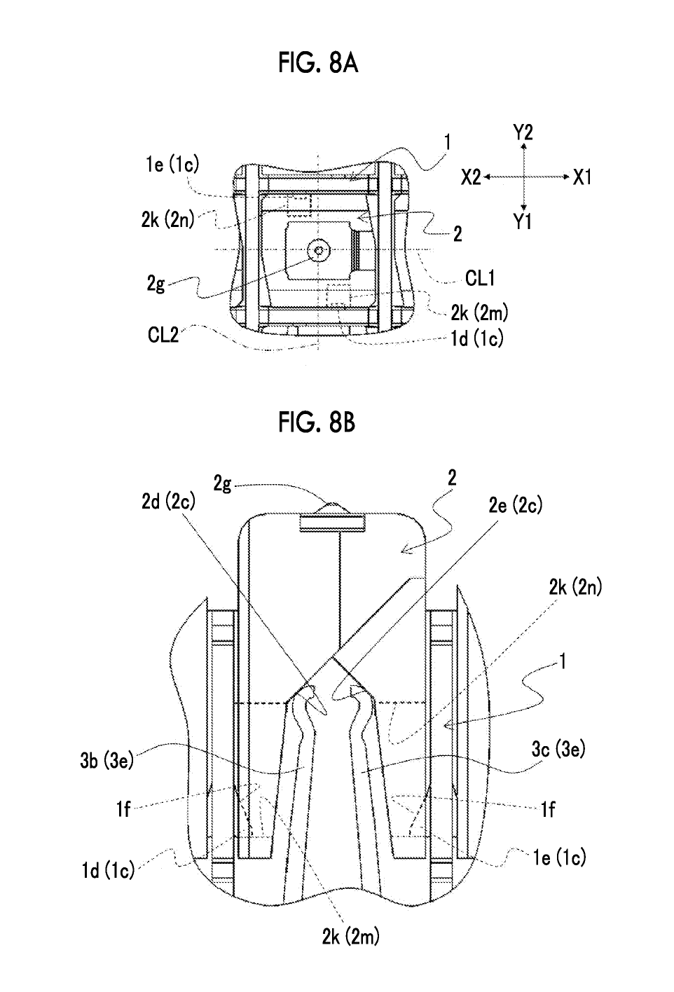

First, the configuration of the electronic component socket 100 will be described with reference to FIGS. 1 to 6B, and 8A and 8B. FIG. 1 is a perspective view showing the configuration of the electronic component socket 100. Moreover, for ease of explanation, in FIG. 1, the electronic component socket 100 is partially cut out, and a portion of movement members 2 is not shown. FIG. 2 is a perspective view showing a configuration of a contact unit U10. FIGS. 3A and 3B are views showing the movement member 2, FIG. 3A is a perspective view when the movement member 2 is viewed from the upper portion, and FIG. 3B is a perspective view when the movement member 2 is viewed from the lower portion. FIG. 4 is a perspective view showing a contact bar B10. FIG. 5 is a plan view showing a disposition example of a first elastic contact portion 3b and a second elastic contact portion 3c. FIGS. 6A and 6B are views showing a disposition position of the first elastic contact portion 3b and the second elastic contact portion 3c in the first embodiment, FIG. 6A is a plan view showing the disposition position of the first elastic contact portion 3b and the second elastic contact portion 3c, and FIG. 6B is an enlarged view showing a D portion shown in FIG. 6A. Moreover, in FIGS. 5, 6A, and 6B, for ease of explanation, the electronic component socket 100 is partially shown, and the movement member 2 is not shown. FIGS. 8A and 8B are views showing an engagement state between a protrusion 1c and a concave portion 2k, FIG. 8A is a plan view showing a protrusion 1c and a concave portion 2k viewed from the upper side, and FIG. 8B is a side view showing a state where FIG. 8A is viewed from the X2 direction side. Moreover, in FIG. 8B, a portion of a shield body 1 is not shown.

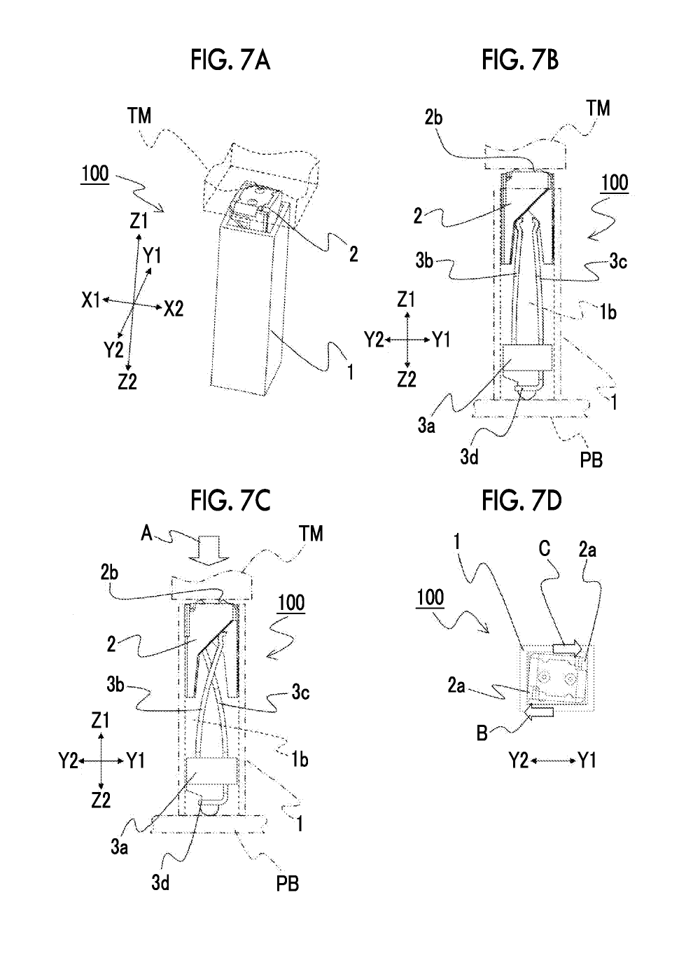

As shown in FIG. 1, the electronic component socket 100 may include the shield bodies 1 configured of a plurality of sheets of shield plates 1a, contact units U10 which may electrically connect electrode terminals TM (refer to FIGS. 7A to 7D) of electronic components and a wiring of a wiring substrate PB (refer to FIGS. 7A to 7D), and a housing 4 which can hold the shield bodies 1 and the contact units U10. As shown in FIGS. 1 and 2, the contact unit U10 may include the movement member 2 and an elastic member 3.

As shown in FIG. 1, in the shield body 1, the plurality of sheets of shield plates 1a, which may be configured of metal plate pieces and have conductivity, may be formed to be combined in a lattice shape so that the cross-section is formed in an approximately rectangular shape, and the shield body has an opening portion 1b in which a space is formed in the inner portion of the lattice. Moreover, the lattices formed by combining the shield plates 1a form rows and columns in two directions orthogonal to each other. The shield body 1 may include the protrusion 1c protruding toward a center of the opening portion 1b in the opening portion 1b, and the protrusion 1c may be formed by protrusion-processing the shield body 1 formed of a metal plate. Moreover, in the present embodiment, as shown in FIG. 6B, the protrusion 1c may include: a first protrusion 1d which may be provided on one side (Y1 direction side) with respect to a first center line CL1 bisecting an opening end portion of the opening portion 1b in a plan view and on one side (X1 direction side) with respect to a second center line CL2 orthogonal to the first center line CL1, and may protrude in the center direction of the opening portion 1b; and a second protrusion 1e which is provided on the other side (Y2 direction side) with respect to the first center line CL1 and on the other side (X2 direction side) with respect to the second center line CL2, and may protrude in a direction opposite to the protrusion direction of the first protrusion 1d. Moreover, the second center line CL2 also bisects the opening end portion. In addition, as shown in FIGS. 8A and 8B, a sliding inclination surface 1f which may be inclined downward in the protrusion direction of the protrusion 1c may be provided on the upper portion (Z direction side) of the protrusion 1c.

As shown in FIGS. 3A and 3B, the movement member 2 may be formed in an approximately rectangular parallelepiped shape. The movement member 2 may include a seat portion 2f and a conductive member 2h. The seat portion 2f may be formed of a synthetic resin material and in an approximately rectangular parallelepiped shape, and may include a concave portion 2k having a concave shape on the side surface. Moreover, in the present embodiment, the concave portion 2k may be formed as a through hole. The conductive member 2h may include a grounded contact portion 2a which may be electrically connectable to the shield body 1, a contact portion 2b which can contact the electrode terminal TM (refer to FIGS. 7A to 7D) of an electronic component having conductivity, and an inclined surface portion 2c which may be electrically connected to the contact portion 2b. The grounded contact portion 2a, the contact portion 2b, and the inclined surface portion 2c may be formed of one sheet of metal plate, and the grounded contact portion 2a, the contact portion 2b, and the inclined surface portion 2c may be electrically connected to one another. Moreover, the seat portion 2f and the conductive member 2h may be integrally formed, the contact portion 2b may be formed on the upper surface (the surface of the Z1 side) of the seat portion 2f with which the electrode terminal TM of the electronic component can contact, the grounded contact portion 2a may be formed on the side surface (the surface of the X1-X2 side or the surface of the Y1-Y2 side) of the seat portion 2f, and the inclined surface portion 2c may be formed on the lower surface (the surface of the Z2 side) of the seat portion 2f. Moreover, the inclined surface portion 2c may be formed on the rear side of the concave portion 2k, and extend so as to be close to the side, on which the concave portion 2k is provided, toward the lower portion. In addition, the plurality of movement members 2 may be disposed to correspond to the electrode terminals TM of the electron components, and may be classified into members which are used for grounding and members which are not used for grounding. When the movement member is the member which is not used for grounding, the grounded contact portion 2a is not formed.

Moreover, as shown in FIGS. 8A and 8B, the concave portion 2k may include: a first concave portion 2m which may be provided on one side (Y1 direction side) of the seat portion 2f with respect to the first center line CL1 and on one side (X1 direction side) with respect to the second center line CL2; and a second concave portion 2n which may be provided on the other side (Y2 direction side) of the seat portion 2f with respect to the first center line CL1 and on the other side (X2 direction side) with respect to the second center line CL2. In addition, the grounded contact portion 2a may be formed on the side surface on the Y1 direction side and the side surface on the Y2 direction side of the seat portion 2f. Moreover, the inclined surface portion 2c may include: a first inclined surface portion 2d which may be formed on the rear side of the first concave portion 2m, and may extend so as to be close to the side, on which the first concave portion 2m is provided, toward the lower portion, and a second inclined surface portion 2e which may be formed on the rear side of the second concave portion 2n and extend so as to be close to the side, on which the second concave portion 2n is provided, toward the lower portion, and a protruding portion 2g protruding in the Z1 direction may be formed on the contact portion 2b. One protruding portion 2g may be provided, or two protruding portions 2g may be provided if necessary.

As shown in FIG. 2, the elastic member 3 may include a biasing portion 3e which may be formed of a metal plate, and may have conductivity and a biasing force, and a base portion 3a which may be formed of a synthetic resin material and in a rectangular parallelepiped shape, and may fix the biasing portion 3e. The biasing portion 3e may protrude upward from the upper surface (the surface of the Z1 side) of the base portion 3a, may be formed in a cantilever spring shape, and can be displaced in the Y1-Y2 direction in FIG. 2. In addition, the elastic member 3 may include a contact portion 3d which may be formed to protrude from the lower surface (the surface of the Z2 side) of the base portion 3a being formed of a metal plate and can contact a wiring of the wiring substrate PB, and the biasing portion 3e may be electrically connected to the contact portion 3d. Accordingly, the biasing portion 3e may be electrically connectable to the wiring of the wiring substrate PB which is placed below the opening portion 1b. Moreover, in the present embodiment, the biasing portion 3e may include a first elastic contact portion 3b which may elastically contact the first inclined surface portion 2d, and a second elastic contact portion 3c which may elastically contact the second inclined surface portion 2e.

Moreover, the contact unit U10 shown in FIG. 2 has the configuration in which one set of first elastic contact portion 3b and second elastic contact portion 3c are provided on the base portion 3a. However, in the present embodiment, as shown in FIG. 4, a contact bar B10 in which a plurality of sets of first elastic contact portions 3b and second elastic contact portions 3c are provided on the base portion 3a may be used.

Moreover, as shown in FIG. 5, the first elastic contact portions 3b and the second elastic contact portions 3c may be configured so that bases of the first elastic contact portions 3b and bases of the second elastic contact portions 3c may be disposed in parallel on the same virtual straight line L1 assumed on the upper surface of the base portion 3a. However, in the present embodiment, as shown in FIGS. 6A and 6B, the bases of the first elastic contact portions 3b may be disposed on one virtual straight line L2 of two virtual parallel lines assumed on the upper surface of the base portion 3a, the bases of the second elastic contact portions 3c may be disposed on the other virtual straight line L3 of the two virtual parallel lines, and thus, the bases of the first elastic contact portions and the bases of the second elastic contact portions may be positioned at different positions along extension directions of the two virtual parallel lines.

As shown in FIG. 1, the housing 4 may be formed of a synthetic resin material and in an approximately rectangular parallelepiped shape, and may include an accommodation portion 4a in which the shield body 1 and the contact unit U10 can be disposed.

Next, the structure of the electronic component socket 100 will be described with reference to FIGS. 1 and 2. As shown in FIG. 1, the electronic component socket 100 may have the structure in which the contact units U10 are disposed in opening portions 1b of the lattice of the shield bodies 1. At this time, the movement member 2 is disposed to move vertically on the upper portion of the elastic member 3 in the opening portion 1b, and as shown in FIG. 2, is disposed in a state where the biasing portion 3e elastically contacts the inclined surface portion 2c of the movement member 2, that is, in a state where the first inclined surface portion 2d and the first elastic contact portion 3b abut each other and the second inclined surface portion 2e and the second elastic contact portion 3c elastically contact each other. Accordingly, the elastic member 3 is electrically connected to the wiring of the wiring substrate PB (refer to FIGS. 7A to 7D), is electrically connected to the inclined surface portion 2c of the movement member 2, and is electrically connectable to the electrode terminal TM (refer to FIGS. 7A to 7D) of the electronic component via the contact portion 2b. In addition, the movement member 2 may be disposed to be movable in the pressed direction (Z2 direction) according to the contact between the movement member and the electronic component. Moreover, the movement member 2 may be inserted into the opening portion 1b by snap-in, and after the insertion, the protrusion 1c formed in the opening portion 1b of the shield body 1 and the concave portion 2k of the movement member 2 engage with each other. That is, the first protrusion 1d and the first concave portion 2m may engage with each other, and the second protrusion 1e and the second concave portion 2n engage with each other. Therefore, the movement member 2 inserted in the opening portion 1b is held in the opening portion 1b in the state where the biasing portion 3e is bent.

Next, the operation of the electronic component socket 100 will be described with reference to FIGS. 7A to 7D. FIGS. 7A to 7D are views for an operational explanation of the electronic component socket 100, FIG. 7A is a perspective view showing the electronic component socket 100, FIG. 7B is a side view showing the electronic component socket 100 in an initial state, FIG. 7C is a side view showing the electronic component socket 100 after the operation, and FIG. 7D is a top view showing the electronic component socket 100 after the operation. Moreover, in FIGS. 7A to 7D, for ease of explanation, the operation in one set of contact unit U10 is described.

If the electronic component is attached to the electronic component socket 100, first, as shown in FIG. 7B, the electrode terminal TM of the electronic component placed above the opening portion 1b and the contact portion 2b of the movement member 2 contact each other, and the electric connection between the electronic component and the electronic component socket 100 is realized. Thereafter, as shown in FIG. 7C, if the movement member 2 is pressed in a direction of an arrow A, the first elastic contact portion 3b may be bent along the first inclined surface portion 2d, the second elastic contact portion 3c may be bent along the second inclined surface portion 2e, the movement member 2 may move in the direction of the arrow A, and the electric connection between the electronic component and the electronic component socket 100 becomes more stable. At this time, according to the movement of the movement member 2, the force biased in the direction against the movement of the movement member 2 may be applied to the first inclined surface portion 2d and the second inclined surface portion 2e from the first elastic contact portion 3b and the second elastic contact portion 3c. Accordingly, a component force in a direction perpendicular to the direction against the movement of the movement member 2 may be applied to the first inclined surface portion 2d and the second inclined surface portion 2e. As shown in FIG. 7D, the component force may be operated in directions of an arrow B and an arrow C, a rotational moment may be operated in the movement member 2, the movement member 2 may be rotated about a virtual axis parallel to the movement direction of the movement member 2, and the grounded contact portion 2a and the inner circumferential surface of the shield body 1 contact each other. Accordingly, when the contact unit U10 is used for grounding, the grounded contact portion 2a may be electrically connected to the inner circumferential surface of the shield body 1, and can be grounded. Moreover, coating, plating, or the like having insulation properties may be applied to the shield plate 1a at the location corresponding to the contact unit U10 which is not used for grounding, and thus, even when the grounded contact portion 2a of the contact unit U10 which is not used for grounding and the shield body 1 contact each other, the grounding is not realized. Moreover, when the contact unit U10 is used for grounding, although it is not shown, the contact portion 3d and the shield body 1 may be electrically connected to each other by a method such as connecting using a circuit or connecting using conductive adhesive or solder. In addition, the force is operated in the directions of arrows B and C, the rotational moment is operated in the movement member 2, and thus, the concave portion 2k is biased toward the protrusion 1c.

In addition, if the electronic component is removed from the electronic component socket 100, the movement member 2 is returned to the position of the initial state shown in FIG. 7B by the biasing forces of the first elastic contact portion 3b and the second elastic contact portion 3c. Since the concave portion 2k engages with the protrusion 1c of the shield body, the movement member 2 returned to the position of the initial state is prevented from being removed so that the movement member does not fall off from the opening portion 1b of the shield body 1.

In the electronic component socket 100 of the present embodiment, the electronic component socket may include: the shield body 1 which forms the opening portion 1b and has conductivity; the movement member 2 which may include the conductive member 2h having the contact portion 2b capable of contacting the electrode terminal TM of the electronic component placed above the opening portion 1b; and the elastic member 3 which may be electrically connectable to the wiring of the wiring substrate PB placed below the opening portion 1b and may include the biasing portion 3e having the biasing force and the base portion 3a fixing the biasing portion 3e, in which the movement member 2 is disposed to move vertically above the elastic member 3 in the opening portion 1b, and the biasing portion 3e elastically contacts the movement member 2, the shield body 1 may include the protrusion 1c protruding toward the center side of the opening portion 1b in the opening portion 1b, the movement member 2 may include the concave portion 2k which engages with the protrusion 1c, the conductive member 2h may include the inclined surface portion 2c which may be formed on the rear side of the concave portion 2k and may extend so as to be close to the side, on which the concave portion 2k is provided, toward the lower portion, and the biasing portion 3e of the elastic member elastically contacts the inclined surface portion 2c.

Accordingly, since the protrusion 1c is easily formed compared to a cut-and-raised portion, a reduction in the size can be easily achieved. In addition, the conductive member 2h included in the movement member 2 may include the inclined surface portion 2c which may be formed on the rear side of the concave portion 2k and may extend so as to be close to the side on which the concave portion 2k is provided toward the lower portion, and the biasing portion 3e of the elastic member 3 elastically contacts the inclined surface portion 2c from the lower portion. Accordingly, the movement member 2 may be biased upward by the elastic force of the biasing portion 3e, and may be biased to the direction in which the protrusion 1c is provided. That is, the concave portion 2k may be pressed to the protrusion 1c, and thus, engagement between the protrusion 1c and the concave portion 2k may be securely performed. Accordingly, the electronic component socket, in which the removal preventing structure can be processed without being limited by a size of the conductive member 2h and desired removal prevention strength can be obtained, can be provided.

In addition, in the electronic component socket 100 of the present embodiment, the shield body 1 may be formed of a metal plate, and the protrusion 1c may be formed by protrusion-processing the shield body 1 formed of a metal plate.

Accordingly, since the shield body 1 is formed of a metal plate, compared to a case where, for example, the shield body is formed of a plate-shaped member of a synthetic resin material and is subjected to the processing for providing conductivity, the shield body can be easily formed. Moreover, since the protrusion 1c may be formed by the protrusion-processing, compared to the cut-and-raised portion, there is an advantageous effect in that the reduction in the size can be easily achieved, damage does not easily occur, and yield can be improved.

In addition, in the electronic component socket 100 of the present embodiment, the shield body 1 may include: the first protrusion 1d which may be provided on one side with respect to the first center line CL1 bisecting the opening end portion of the opening portion 1b in a plan view and on one side with respect to the second center line CL2 orthogonal to the first center line CL1, and may protrude in the center direction of the opening portion 1b; and the second protrusion 1e which may be provided on the other side with respect to the first center line CL1 and on the other side with respect to the second center line CL2, and may protrude in a direction opposite to the protrusion direction of the first protrusion 1d, the movement member 2 may include: the first concave portion 2m which may be provided on one side with respect to the first center line CL1 and on one side with respect to the second center line CL2, and may engage with the first protrusion 1d; and the second concave portion 2n which may be provided on the other side with respect to the first center line CL1 and on the other side with respect to the second center line CL2, and may engage with the second protrusion 1e, the inclined surface portion 2c of the conductive member 2h may include: the first inclined surface portion 2d which may be formed on the rear side of the first concave portion 2m and may extend so as to be close to the side, on which the first concave portion 2m is provided, toward the lower portion; and a second inclined surface portion 2e which may be formed on the rear side of the second concave portion 2n and may extend so as to be close to the side, on which the second concave portion 2n is provided, toward the lower portion, and the biasing portion 3e of the elastic member 3 may include the first elastic contact portion 3b which elastically contacts the first inclined surface portion 2d, and the second elastic contact portion 3c which elastically contacts the second inclined surface portion 2e.

Accordingly, the first protrusion 1d and the first concave portion 2m may be provided on one side with respect to the first center line CL1 bisecting the opening end portion of the opening portion 1b in a plan view and on one side with respect to the second center line CL2 orthogonal to the first center line CL1, the second protrusion 1e and the second concave portion 2n may be provided on the other side with respect to the first center line CL1 and on the other side with respect to the second center line CL2, and thus, the movement member 2 may be engaged at two locations, and falling-out of the movement member 2 does not easily occur. In addition, the first inclined surface portion 2d and the second inclined surface portion 2e are biased in directions opposing each other in a plan view, respectively, and thus, the movement member 2 is rotated along a plane perpendicular to the movement direction. Accordingly, the movement member 2 is not easily inclined with respect to the movement direction, and the engagement between the protrusion 1c and the concave portion 2k is not easily released. That is, the shield body 1 and the movement member 2 engage with each other at two locations, the movement member 2 is not easily inclined with respect to the movement direction, and the engagement between the protrusion 1c and the concave portion 2k is not easily released. Therefore, there is an advantageous effect in that the electronic component socket more easily capable of obtaining desired removal prevention strength can be provided.

In the electronic component socket 100 as described above, the elastic member 3 may include two biasing portions 3e of the first elastic contact portion 3b and the second elastic contact portion 3c, the movement member 2 may include two inclined surface portions 2c of the first inclined surface portion 2d and the second inclined surface portion 2e, and two concave portions 2k of the first concave portion 2m and the second concave portion 2n, and the shield body 1 may include two protrusions 1c of the first protrusion 1d and the second protrusion 1e. The electronic component socket 200 may include one protrusion 1c of the shield body 1, one biasing portion 3e of the elastic member 3, and one inclined surface portion 2c and one concave portion 2k of the movement member 2. In below descriptions, the detailed descriptions are omitted with respect to structures similar to the electronic component socket 100 described above, and constitution part names, part names, and reference numerals of the electronic component socket 100 are used.

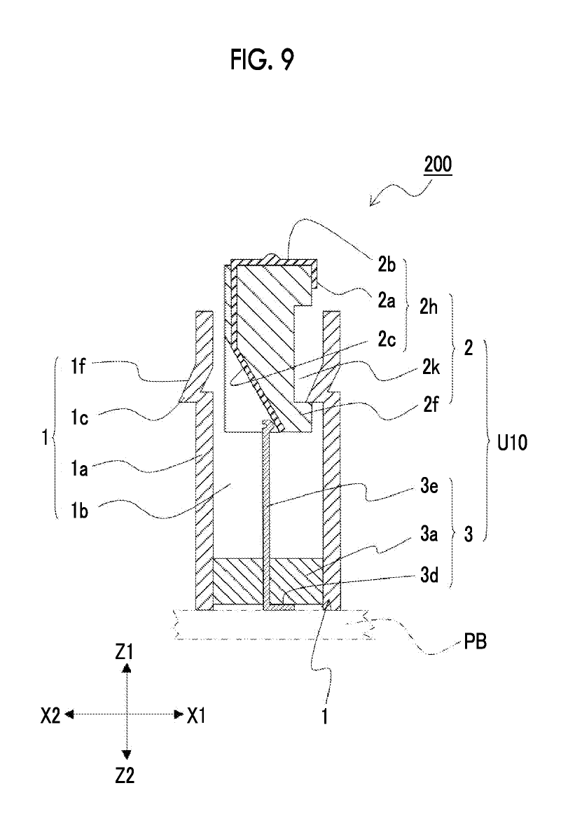

First, the configuration of the electronic component socket 200 will be described with reference to FIG. 9. FIG. 9 is a schematic view showing the configuration of the electronic component socket 200 according to an example embodiment. In addition, in FIG. 9, only a portion of the electronic component socket 200 is shown, and the housing 4 is not shown.

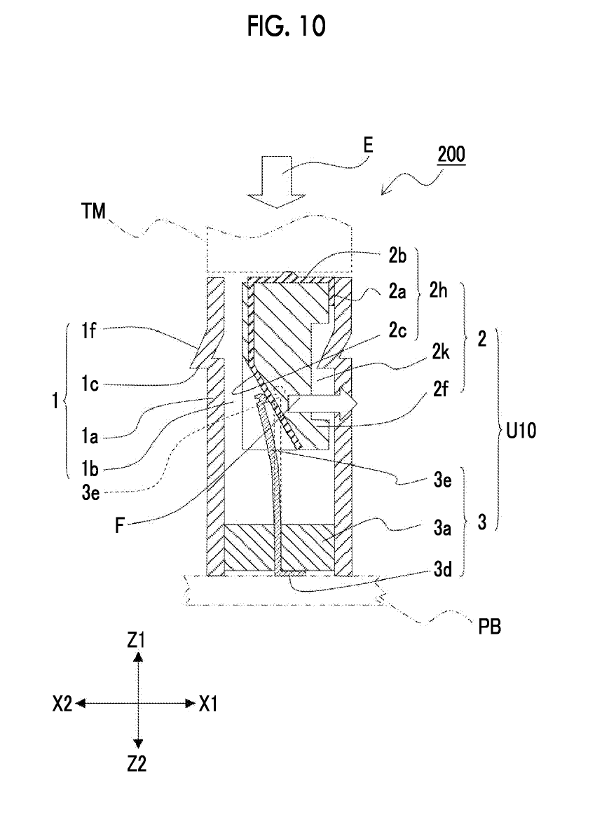

As shown in FIG. 9, the electronic component socket 200 may include shield bodies 1 configured of the plurality of sheets of shield plates 1a, contact units U10 which electrically connect electrode terminals TM (refer to FIG. 10) of electronic components and the wiring of the wiring substrate PB, and a housing 4 (not shown) which can hold the shield bodies 1 and the contact units U10. The contact unit U10 may include the movement member 2 and the elastic member 3.

As shown in FIG. 9, in the shield body 1, the plurality of sheets of shield plates 1a, which may be composed of metal plate pieces and have conductivity, are formed to be combined in a lattice shape so that the cross-section is formed in an approximately rectangular shape, and the shield body may have an opening portion 1b in which a space is formed in the inner portion of the lattice. Moreover, the lattices formed by combining the shield plates 1a form rows and columns in two directions orthogonal to each other. The shield body 1 may include one protrusion 1c protruding toward a center of the opening portion 1b in the opening portion 1b, and the protrusion 1c is formed by protrusion-processing the shield body 1.

As shown in FIG. 9, the movement member 2 is formed in an approximately rectangular parallelepiped shape. The movement member 2 may include the seat portion 2f and the conductive member 2h. The seat portion 2f may be formed of a synthetic resin material, may be formed in an approximately rectangular parallelepiped shape, and may include a concave portion 2k which may be formed in a concave shape on one side surface (the side surface of the X1 direction side). The conductive member 2h may include a grounded contact portion 2a which may be electrically connectable to the shield body 1, a contact portion 2b which can contact the electrode terminal TM (refer to FIG. 10) of an electronic component providing conductivity, and an inclined surface portion 2c which may be electrically connected to the contact portion 2b. The grounded contact portion 2a, the contact portion 2b, and the inclined surface portion 2c may be formed of one sheet of metal plate, and the grounded contact portion 2a, the contact portion 2b, and the inclined surface portion 2c may be electrically connected to one another. Moreover, the seat portion 2f and the conductive member 2h may be integrally formed, the contact portion 2b may be formed on the upper surface (the surface of the Z1 side) of the base portion 2f with which the electrode terminal TM of the electronic component can contact, the grounded contact portion 2a may be formed on the side surface (the surface on the X1 direction side) on which the concave portion 2k of the seat portion 2f is formed, and the inclined surface portion 2c may be formed on the lower surface (the surface of the Z2 side) of the base portion 2f. Moreover, the inclined surface portion 2c may be formed on the rear side of the concave portion 2k, and may extend so as to be close to the side, on which the concave portion 2k is provided, toward the lower portion. In addition, the movement member 2 shown in FIG. 9 may correspond to the terminal for grounding, and when the movement member corresponds to the terminal which is not used for grounding, the grounded contact portion 2a may not be formed.

As shown in FIG. 9, the elastic member 3 may include a biasing portion 3e which may be formed of a metal plate, and may have conductivity and a biasing force, and a base portion 3a which may be formed of a synthetic resin material, may be formed in a rectangular parallelepiped shape, and may fix the biasing portion 3e. The biasing portion 3e may protrude upward from the center portion of the upper surface (the surface of the Z1 side) of the base portion 3a, may be formed in one cantilever spring shape, and can be displaced in the X1-X2 direction in FIG. 9. In addition, the elastic member 3 may include a contact portion 3d which may be formed to protrude from the lower surface (the surface of the Z2 side) of the base portion 3a being formed of a metal plate and can contact the wiring of the wiring substrate PB, and the biasing portion 3e may be electrically connected to the contact portion 3d. Accordingly, the biasing portion 3e may be electrically connectable to the wiring of the wiring substrate PB which may be placed below the opening portion 1b.

The housing 4 (not shown) may be formed of a synthetic resin material, may be formed in an approximately rectangular parallelepiped shape, and may be formed to dispose the shield body 1 and the contact unit U10.

As shown in FIG. 9, the electronic component socket 200 may have the structure in which the contact units U10 are disposed in opening portions 1b of the lattices of the shield bodies 1. At this time, the movement member 2 may be disposed to move vertically on the upper portion of the elastic member 3 in the opening portion 1b, and may be disposed in the state where the biasing portion 3e elastically contacts the inclined surface portion 2c of the movement member 2. Accordingly, the elastic member 3 may be electrically connected to the wiring of the wiring substrate PB (refer to FIG. 10), may be electrically connected to the inclined surface portion 2c of the movement member 2, and may be electrically connectable to the electrode terminal TM (refer to FIG. 10) of the electronic component via the contact portion 2b. In addition, the movement member 2 may be disposed to be movable in the pressed direction (Z2 direction) according to the contact between the movement member and the electronic component. Moreover, the movement member 2 may be inserted into the opening portion 1b by snap-in, and after the insertion, the protrusion 1c formed in the opening portion 1b of the shield body 1 and the concave portion 2k of the movement member 2 engage with each other. Therefore, the movement member 2 inserted in the opening portion 1b may be held in the opening portion 1b in the state where the biasing portion 3e is bent.

FIG. 10 is a schematic view for an operation explanation of the electronic component socket 200 in an example embodiment, and is a view showing the state where the socket is pressed downward from the state shown in FIG. 9.

When the electronic component is not attached to the electronic component socket 200, as shown in FIG. 9, in the electronic component socket 200, the movement member 2 may be biased upward by the biasing portion 3e of the elastic member 3, the protrusion 1c and the concave portion 2k may engage with each other, and thus, the movement member 2 may be held without falling off of the opening portion 1b. If the electronic component is attached to the electronic component socket 200, as shown in FIG. 10, from the state shown in FIG. 9, first, the electrode terminal TM of the electronic component placed above the opening portion 1b and the contact portion 2b of the movement member 2 contact each other, and the electric connection between the electronic component and the electronic component socket 200 is realized. Thereafter, if the movement member 2 is pressed in a direction of an arrow E (Z2 direction), the biasing portion 3e is bent along the inclined surface portion 2c, and the electric connection between the electronic component and the electronic component socket 200 becomes more stable. At this time, according to the movement of the movement member 2, the force biased in the direction against the movement of the movement member 2 is applied from the biasing portion 3e to the inclined surface portion 2c. Accordingly, a component force in a direction perpendicular to the direction against the movement of the movement member 2 may be applied to the inclined surface portion 2c. As shown in FIG. 10, since the component force is operated in an arrow F direction (X1 direction), the movement member 2 moves in the direction in which the concave portion 2k is formed, and the grounded contact portion 2a and the inner circumferential surface of the shield body 1 contact each other. Accordingly, when the contact unit U10 is used for grounding, the grounded contact portion 2a is electrically connected to the inner circumferential surface of the shield body 1, and can be grounded. Moreover, coating, plating, or the like having insulation properties may be applied to the shield plate 1a at the location corresponding to the contact unit U10 which is not used for grounding, and thus, even when the grounded contact portion 2a of the contact unit U10 which is not used for grounding and the shield body 1 contact each other, the grounding is not realized. Moreover, when the contact unit U10 is used for grounding, although it is not shown, the contact portion 3d and the shield body 1 may be electrically connected to each other by, for example, a method such as connecting using a circuit or connecting using conductive adhesive or solder. In addition, the force may be operated in the direction of the arrow F, and thus, the concave portion 2k may be biased toward the protrusion 1c.

In the electronic component socket 200 according to an example embodiment may include: the shield body 1 which forms the opening portion 1b and has conductivity; the movement member 2 which may include the conductive member 2h having the contact portion 2b capable of contacting the electrode terminal TM of the electronic component placed above the opening portion 1b; and the elastic member 3 which may be electrically connectable to the wiring of the wiring substrate PB placed below the opening portion 1b and may include the biasing portion 3e having the biasing force and the base portion 3a fixing the biasing portion 3e, in which the movement member 2 may be disposed to move vertically above the elastic member 3 in the opening portion 1b, and the biasing portion 3e elastically contacts the movement member 2, the shield body 1 may include one protrusion 1c protruding toward the center side of the opening portion 1b in the opening portion 1b, the movement member 2 may include one concave portion 2k which engages with the protrusion 1c, the conductive member 2h may include one inclined surface portion 2c which may be formed on the rear side of the concave portion 2k and may extend so as to be close to the side, on which the concave portion 2k is provided, toward the lower portion, and the biasing portion 3e of the elastic member elastically contacts the inclined surface portion 2c.

Accordingly, since the protrusion 1c is more easily formed compared to a cut-and-raised portion, a reduction in the size can be easily achieved. In addition, the conductive member 2h included in the movement member 2 may include the inclined surface portion 2c which may be formed on the rear side of the concave portion 2k and extends so as to be close to the side on which the concave portion 2k is provided toward the lower portion, and the biasing portion 3e of the elastic member 3 elastically contacts the inclined surface portion 2c from the lower portion. Accordingly, the movement member 2 may be biased upward by the elastic force of the biasing portion 3e, and may be biased to the direction in which the protrusion 1c is provided. That is, the concave portion 2k may be pressed to the protrusion 1c, and thus, engagement between the protrusion 1c and the concave portion 2k is securely performed. Accordingly, the electronic component socket, in which the removal preventing structure can be processed without being limited by the size of the conductive member 2h and desired removal prevention strength can be obtained, can be provided.

In the electronic component socket 100 and the electronic component socket 200 described above, the shield body 1 may be formed of the plurality of metal plates, and the shield body 1 may be configured to be fixed and incorporated in the housing 4. Moreover, the protrusion 1c provided in the shield body 1 and the concave portion 2k provided in the movement member 2 engage with each other, and the movement member 2 may be configured to be prevented from falling off of the opening portion 1b of the shield body 1. In the electronic component socket 300 according to an example embodiment, the shield body may be integrally formed and may be configured of a resin molded piece to which metal plating is applied. In addition, a protrusion provided in a movement member and a concave portion provided in the shield body engage with each other, and the movement member may be configured to be prevented from falling off of the opening portion of the shield body. In below descriptions, the same constitution part names and portion names are used with respect to the constitution parts and portions having functions similar to the constitution parts and portions which are used in the electronic component socket 100 of the and the electronic component socket 200.

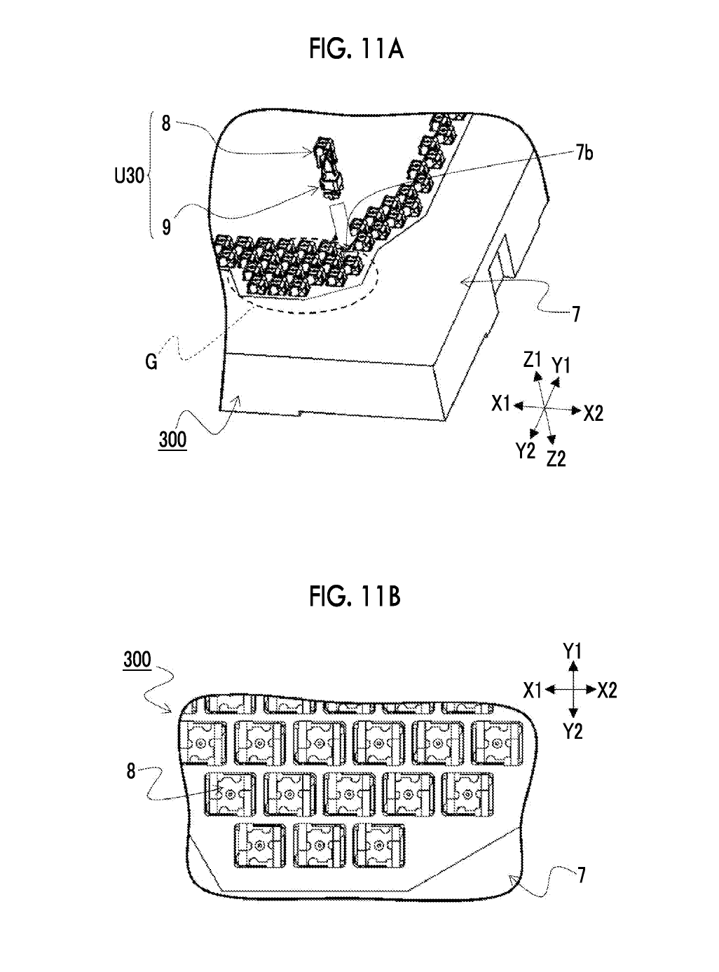

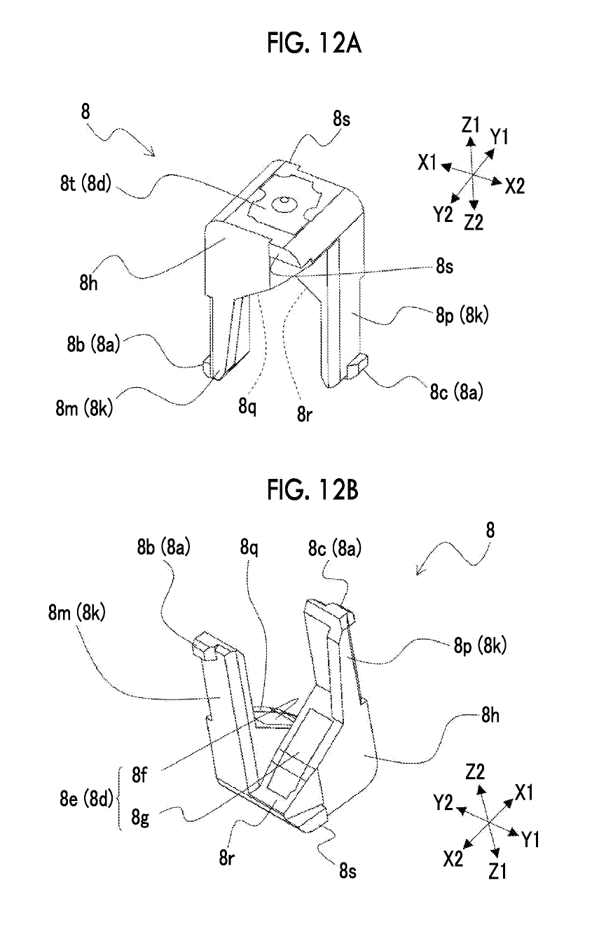

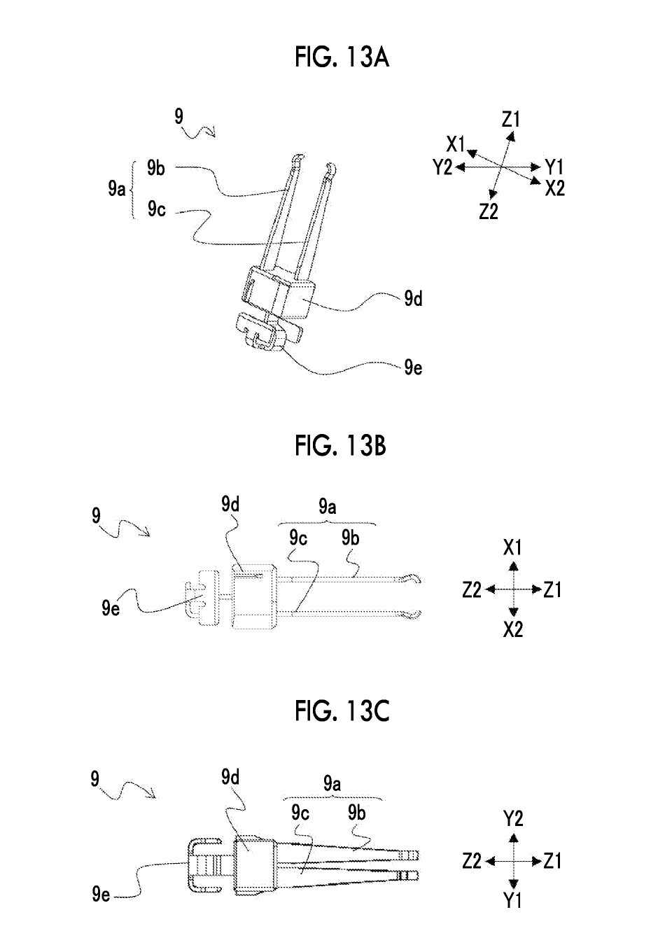

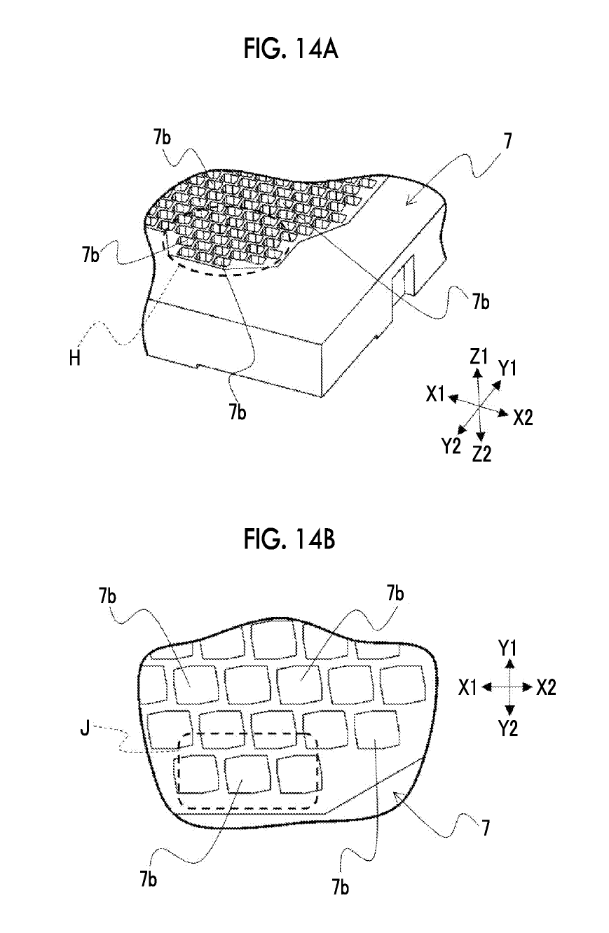

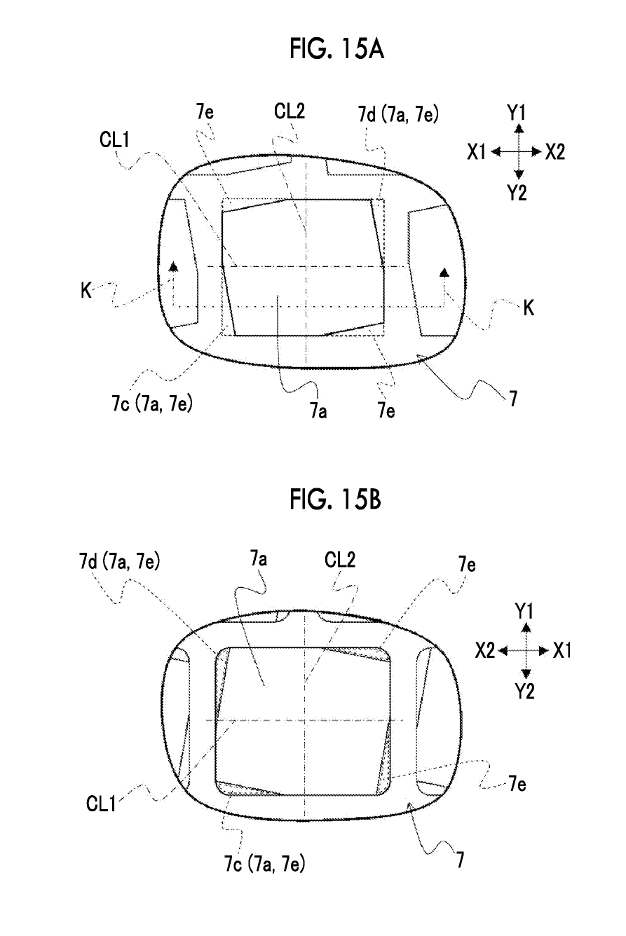

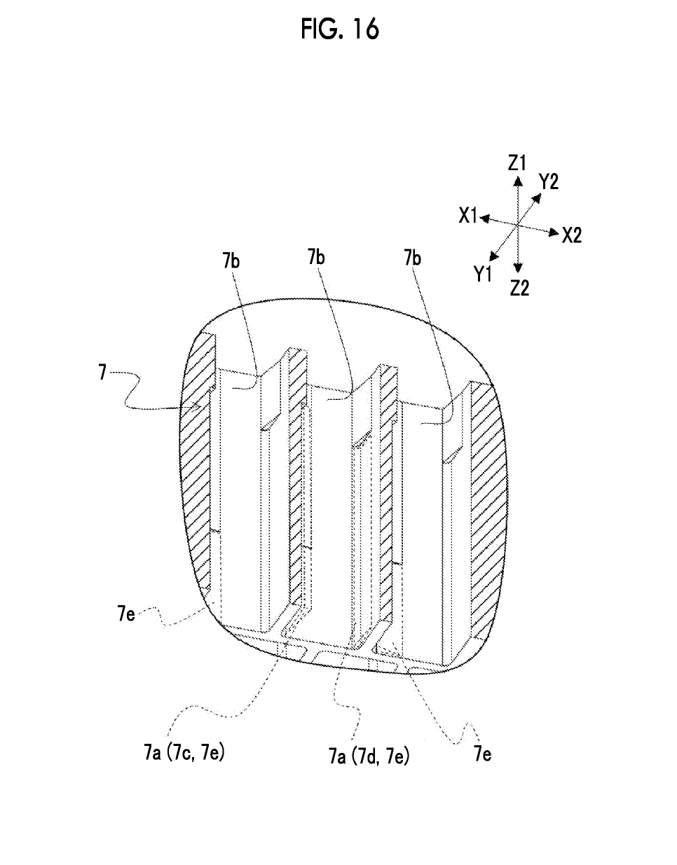

FIGS. 11A and 11B are views showing the electronic component socket 300, FIG. 11A is an enlarged perspective view showing an outline of the electronic component socket 300, and FIG. 11B is an enlarged plan view showing a G portion shown in FIG. 11A viewed from a Z1 direction side. Moreover, the shape of an opening portion 7b of a shield body 7 shown in FIGS. 11A and 11B is schematically shown to be different from the actual shape. FIGS. 12A and 12B are views showing a movement member 8, FIG. 12A is a perspective view showing an outline of the movement member 8, and FIG. 12B is a perspective view showing the movement member 8 viewed from a Z2 direction side shown in FIG. 12A. FIGS. 13A to 13C are views showing an elastic member 9, FIG. 13A is a perspective view showing an outline of the elastic member 9, FIG. 13B is a side view showing the elastic member 9 viewed from a Y2 direction side shown in FIG. 13A, and FIG. 13C is a side view showing the elastic member 9 viewed from an X2 direction side shown in FIG. 13A. FIGS. 14A and 14B are views showing a portion of the shield body 7, FIG. 14A is a perspective view showing a portion of the shield body 7, and FIG. 14B is an enlarged view showing an H portion shown in FIG. 14A viewed from the Z1 direction side. FIGS. 15A and 15B are enlarged views showing a J portion shown in FIGS. 14A and 14B, FIG. 15A is an enlarged view showing the J portion viewed from the Z1 direction, and FIG. 15B is an enlarged view showing the J portion viewed from the Z2 direction side. FIG. 16 is a perspective view showing a cross-section of the opening portion 7b taken along cross-section line K-K shown in FIGS. 15A and 15B, from the Z2 direction side.

As shown in FIGS. 11A and 11B, the electronic component socket 300 may include the shield body 7 which may be configured of one part, and contact units U30 which electrically connect electrode terminals TM (refer to FIG. 10) of electronic components and the wiring of the wiring substrate PB. As shown in FIGS. 11A and 11B, the contact unit U30 may include the movement member 8 and the elastic member 9.

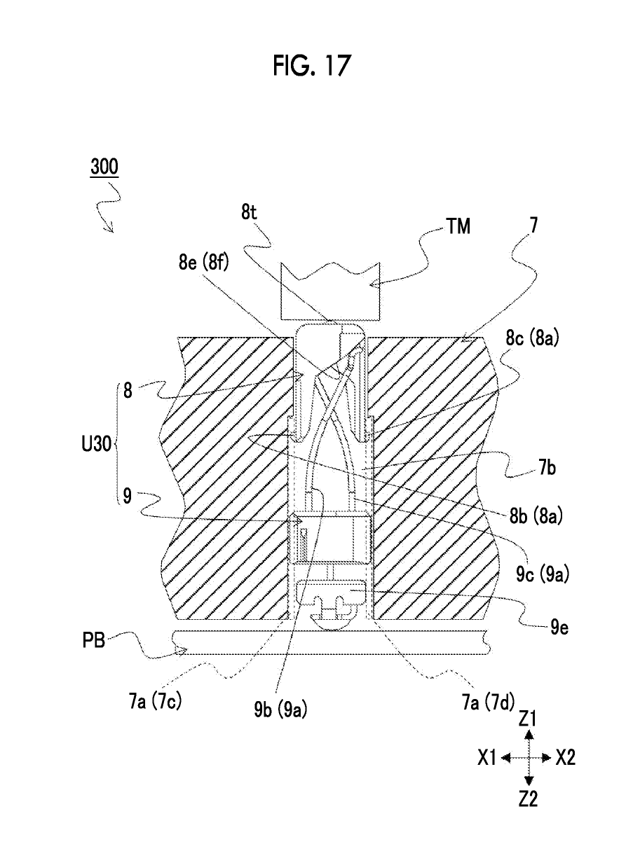

As shown in FIGS. 12A and 12B, the movement member 8 may be formed in an approximately rectangular parallelepiped shape. The movement member 8 may include a seat portion 8h and a conductive member 8d. The seat portion 8h may be formed of a synthetic resin material and may be formed in an approximately rectangular parallelepiped shape. In addition, the seat portion 8h may include legs 8k which extend downward (Z2 direction) from the lower surface (the surface on the Z2 direction side). The legs 8k may include a first leg 8m which may be provided at a corner on the X1 direction side and the Y2 direction side, and a second leg 8p which may be provided at a corner on the X2 direction side and the Y1 direction side, and the corners may be positioned at a pair of diagonal positions on the lower surface of the seat portion 8h. Moreover, the movement member 8 may include protrusions 8a which protrude laterally from the tip portions of the legs 8k, and a corner of each of the legs 8k which continues from the corner of the seat portion 8h is formed to be chamfered. In addition, a first protrusion 8b which is the protrusion 8a provided on the first leg 8m may be formed on the X1 direction side, and a second protrusion 8c which is the protrusion 8a provided on the second leg 8p may be formed on the X2 direction side. In addition, an inclined location may be formed on the lower surface of the seat portion 8h. In the base of the first leg 8m, a first inclined surface 8q may be formed on the side opposite to the side on which the first protrusion 8b is provided, and the first inclined surface 8q may be gradually inclined to the side, on which the first leg 8m is provided, toward the lower portion. Moreover, in the base of the second leg 8p, a second inclined surface 8r may be formed on the side opposite to the side on which the second protrusion 8c is provided, and the second inclined surface 8c may be gradually inclined to the side, on which the second leg 8p is provided, toward the lower portion. In addition, stopper portions 8s laterally protruding may be provided at corners of the upper surface (the surface on the Z1 direction side) of the seat portion 8h corresponding to a pair of diagonal positions which is different from the pair of diagonal positions at which the legs 8k are provided. Each of the stopper portions 8s may be provided to protrude in a direction orthogonal to the direction in which the protrusion 8a protrudes. The stopper portion 8s provided at the corner on the X1 direction side and the Y1 direction side protrudes to the Y1 direction side, and the stopper portion 8s provided at the corner on the X2 direction side and the Y2 direction side protrudes to the Y2 direction side. Moreover, the conductive member 8d may be formed of a metal plate having conductivity, and may include a contact portion 8t which can contact the electrode terminal TM (refer to FIG. 17) of the electrode component, and an inclined surface portion 8e which may be electrically connected to the contact portion 8t. The contact portion 8t and the inclined surface portion 8e may be formed of one sheet of metal plate, and the contact portion 8t and the inclined surface portion 8e may be electrically connected to each other. The conductive member 8d may be integrally formed with the seat portion 8h by insertion molding, the contact portion 8t may be provided to be exposed to the upper surface of the seat portion 8h, and the inclined surface portion 8e may be formed to be exposed to the rear side of the protrusion 8a and may extend so as to be close to the side, on which the protrusion 8a is provided, toward the lower portion. A first inclined surface portion 8f may be formed on the rear side of the first protrusion 8b and may extend so as to be close to the side, on which the first protrusion 8b is provided, toward the lower portion, and the first inclined surface portion may be provided to be exposed along the first inclined surface 8q of the seat portion 8h. Similarly, a second inclined surface portion 8g may be formed on the rear side of the second protrusion 8c and may extend so as to be close to the side, on which the second protrusion 8c is provided, toward the lower portion, and the second inclined surface portion may be provided to be exposed along the second inclined surface 8r of the seat portion 8h.

As shown in FIGS. 13A to 13C, the elastic member 9 may include a biasing portion 9a which may be formed of a metal plate, and may have conductivity and a biasing force, and a base portion 9d which may be formed of a synthetic resin material, may be formed in a rectangular parallelepiped shape, and may fix the biasing portion 9a. The biasing portion 9a may include a first elastic contact portion 9b and a second elastic contact portion 9c which protrude upward from the upper surface (the surface on the Z1 side) of the base portion 9d and may be formed in cantilever spring shapes. The first elastic contact portion 9b and the second elastic contact portion 9c may be disposed at the pair of diagonal positions on the upper surface of the base portion 9d, the first elastic contact portion 9b may be disposed at the corner on the X1 direction side and the Y2 direction side, and the second elastic contact portion 9c may be disposed at the corner on the X2 direction side and the Y1 direction side. Moreover, in FIGS. 13A to 13C, the first elastic contact portion 9b and the second elastic contact portion 9c can be elastically deformed in the X1-X2 direction. In addition, the elastic member 9 may be formed of a metal plate, may be formed to protrude from the lower surface (the surface of the Z2 side) of the base portion 9d, and may include a contact portion 9e which can contact the wiring of the wiring substrate PB, and the biasing portion 9a is electrically connected to the contact portion 9e. Accordingly, the biasing portion 9a may be electrically connectable to the wiring of the wiring substrate PB which is placed below the opening portion 1b.

By disposing the movement member 8 to be overlapped on the upper portion of the elastic member 9 formed in this way, as shown in FIGS. 11A and 11B, the contact unit U30 is formed. In addition, in the movement member 8, the first elastic contact portion 9b elastically contacts the first inclined surface portion 8f, and the second elastic contact portion 9c elastically contacts the second inclined surface portion 8g.

The shield body 7 has conductivity, and as shown in FIGS. 14A and 14B, the plurality of opening portions 7b may be formed in hole shapes along the vertical direction (Z1-Z2 direction). In addition, the shield body 7 may be a resin molded piece which is formed of a synthetic resin material and is integrally formed to have one constitution part, and metal plating of a metal having conductivity is applied to the surface of the shield body. The opening portions 7b may be provided according to the dispositions of the electrode terminals TM of the corresponding electronic components. In addition, as shown in FIG. 15A, in the opening portion 7b, the opening shape when viewed from the upper portion (the Z1 direction side shown in FIGS. 14A and 14B) may be formed in an octagon in which right triangles having the same shapes are cut out from four rectangular corners. Moreover, as shown in FIG. 15B, in the opening portion 7b, the opening shape when viewed from the lower portion (the Z2 direction side shown in FIGS. 14A and 14B) may be formed in a rectangular shape. In this way, in the inner portion of the opening portion 7b which is formed so that the upper opening shape and the lower opening shape are different from each other, as shown in FIG. 16, grooves 7e, which are formed to be concave with respect to the upper side opening shape, are provided upward from the lower side end of the opening portion 7b at locations corresponding to four corners of the rectangular shape which is the lower side opening shape. Here, as shown in FIGS. 15A and 15B, a line bisecting the opening shape of the opening portion 7b is defined as a first center line CL1, and a line which is orthogonal to the first center line CL1 and bisects the opening shape of the opening portion 7b is defined as a second center line CL2. Moreover, in FIGS. 15A and 15B, the first center line CL1 is a line which bisects the opening shape of the opening portion 7b in the Y1-Y2 direction, and the second center line CL2 is a line which bisects the opening shape of the opening portion 7b in the X1-X2 direction. As shown in FIG. 16, in the groove 7e which may be provided on one side (Y2 direction side) with respect to the first center line CL1 and on one side (X1 direction side) with respect to the second center line CL2, and the groove 7e which may be provided on the other side (Y1 direction side) with respect to the first center line CL1 and on the other side (X2 direction side) with respect to the second center line CL2, the lengths of the two grooves 7e from the lower side end of the opening portion 7b may be longer and formed on a more upward side than grooves 7e provided at the other two locations. In this way, the groove 7e having a longer length from the end of the lower side of the opening portion 7b may be referred to as a concave portion 7a. Particularly, the concave portion 7a which is provided on one side with respect to the first center line CL1 and is provided on one side with respect to the second center line CL2 is referred to as a first concave portion 7c, and the concave portion 7a which is provided on the other side with respect to the first center line CL1 and on the other side with respect to the second center line CL2 is referred to as a second concave portion 7d. In this way, the shield body 7 may include the concave portion 7a including the first concave portion 7c and the second concave portion 7d in the opening portion 7b, and the concave portion 7a may be formed by resin forming. Moreover, the opening shape when the opening portion 7b is viewed from the upper portion may be formed to have a size into which the movement member 8 can be inserted, and the opening shape when the opening portion 7b is viewed from the lower portion may be formed to have a size into which the base portion 9d of the elastic member 9 can be inserted.

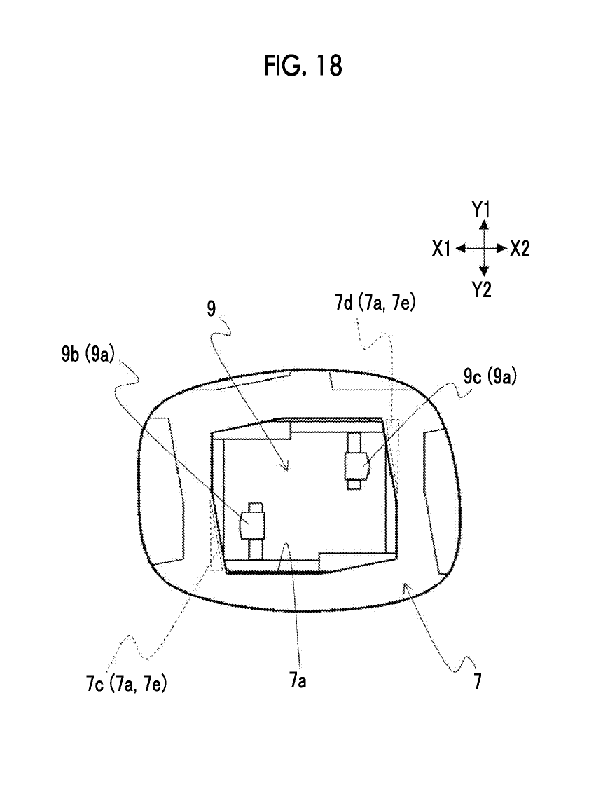

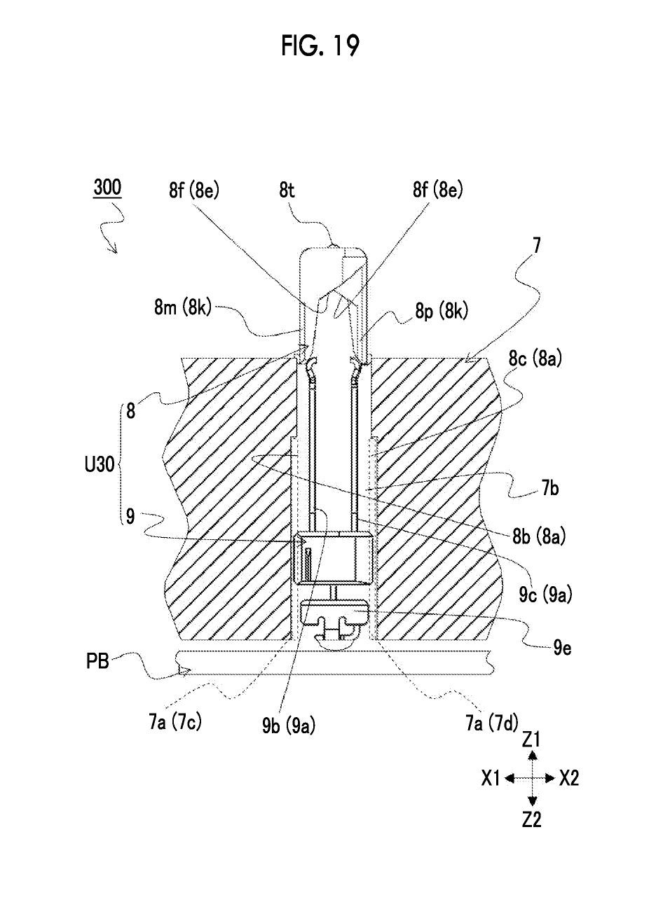

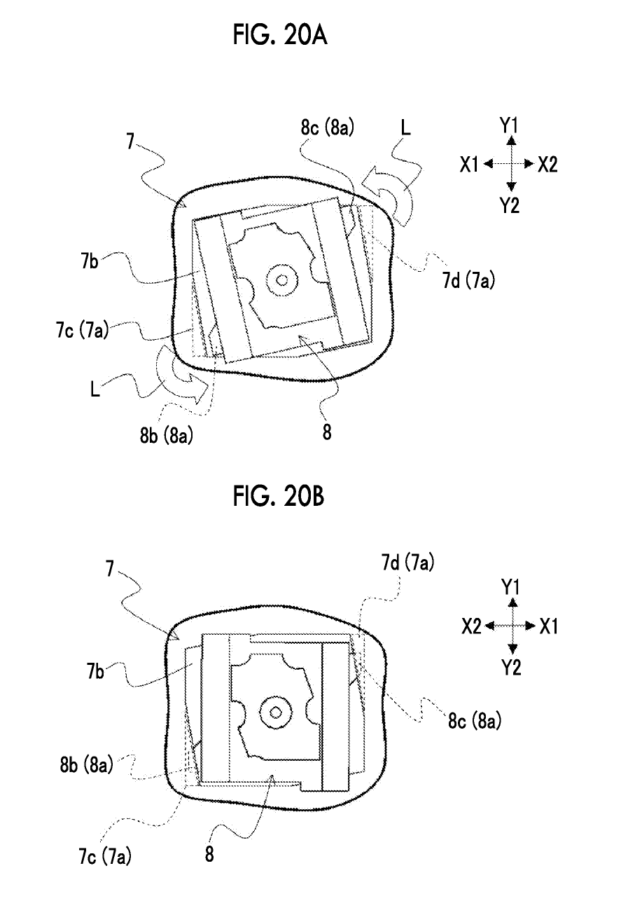

FIG. 17 is a schematic view showing the structure of the electronic component socket 300. Moreover, FIG. 17 shows a state where the socket is disposed on a wiring substrate PB and contacts an electrode terminal TM of the electronic component. FIG. 18 is a plan view showing the state where the elastic member 9 is disposed in the opening portion 7b, from the Z1 direction side shown in FIGS. 11A and 11B. FIG. 19 is a schematic view showing the structure of the electronic component socket 300 before the movement member 8 is incorporated. FIGS. 20A and 20B are views showing a method of inserting the movement member 8 into the opening portion 7b, FIG. 20A is a plan view showing a direction of the movement member 8 when the movement member 8 is inserted into the opening portion 7b, and FIG. 20B is a plan view showing the direction of the movement member 8 after the movement member 8 is inserted into the opening portion 7b.

As shown in FIG. 17, the electronic component socket 300 may be formed so that the contact unit U30 is disposed in the inner portion of each opening portion 7b of the shield body 7.

The elastic member 9, which may be disposed in the inner portion of the opening portion 7b of the shield body 7, is formed so that the biasing portion 9a protrudes to the upper portion. Moreover, as shown in FIG. 18, the elastic member 9 may be accommodated in the inner portion of the opening portion 7b so that the first elastic contact portion 9b which is one biasing portion 9a is disposed in the vicinity of the corner of the opening portion 7b in which the first concave portion 7c is provided, and the second elastic contact portion 9c which is the other biasing portion 9a may be disposed in the vicinity of the corner of the opening portion 7b in which the second concave portion 7d is provided.

In addition, as shown in FIG. 19, the movement member 8 may be inserted from the upper side (Z1 direction side) opening of the opening portion 7b into the inner portion of the opening portion 7b so that the first leg 8m and the first elastic contact portion 9b contact each other, and the second leg 8p and the second elastic contact portion 9c contact each other. At this time, as shown in FIGS. 20A and 20B, in a plan view, the first protrusion 8b may protrude toward the first concave portion 7c of the shield body 7 which is provided on one side (Y2 direction side) with respect to the first center line CL1 (refer to FIGS. 15A and 15B) bisecting the opening end portion of the opening portion 7b and on one side (X1 direction side) with respect to the second center line CL2 (refer to FIGS. 15A and 15B) orthogonal to the first center line CL1. In addition, the second protrusion 8c may be provided on the other side (Y1 direction side) with respect to the first center line CL1 and on the other side (X2 direction side) with respect to the second center line CL2, and may protrude to a direction opposite to the protrusion direction of the first protrusion 8b. As shown in FIG. 19, in the movement member 8, the biasing portions 9a elastically contact the rear side surfaces of the surfaces on which the protrusions 8a of the legs 8k are provided, and the biasing portions 9a may be inserted into the opening portion 7b while being bent. Moreover, when the movement member 8 is inserted into the opening portion 7b from the upper side opening, as shown in FIG. 20A, the protrusion 8a may be inserted in a state where the movement member 8 is rotated in a direction (an arrow L direction) separated from the concave portion 7a, and thus, the movement member 8 can be inserted while the protrusion 8a does not contact the shield body 7. In addition, in FIG. 20A, it is seen that a portion (leg 8k) of the movement member 8 contacts the shield body 7. However, as shown in FIGS. 12A and 12B, since the chamfering is performed on the location that seems to be in contact with the shield body 7, the movement member 8 does not contact the shield body 7. In this way, if the movement member 8 is inserted into the opening portion 7b, the biasing portion 9a may bias the movement member 8 to the upper portion and may bias the movement member to be rotated in a direction opposite to the arrow L. Specifically, as shown in FIG. 17, the first elastic contact portion 9b may bias the first inclined surface portion 8f in the X1 direction, and the second elastic contact portion 9c may bias the second inclined surface portion 8g in the X2 direction. In this way, the movement member 8 may be biased to be rotated in the direction opposite to the arrow L, and thus, as shown in FIG. 20B, the protrusion 8a and the concave portion 7a, which may be disposed so that the first protrusion 8b faces the first concave portion 7c and the second protrusion 8c faces the second concave portion 7d, engage with each other so that the protrusion 8a rotates in a certain direction of the concave portion 7a and the protrusion 8a contacts the upper end side surface of the concave portion 7a. In addition, in FIG. 17, the movement member 8 may contact the electrode terminal TM of the electronic device. However, since the movement member 8 is pressed downward against the biasing force of the elastic member 9, the protrusion 8a may be separated from the upper end side surface of the concave portion 7a. The protrusion 8a and the concave portion 7a may engage with each other, and thus, the movement member 8 may be disposed above the elastic member 9 to be vertically movable without falling out of the opening portion 7b in the state where the contact portion 8t is exposed from the upper side (Z1 direction side) opening of the opening portion 7b, and the contact unit U30 is formed. In addition, at the time, the biasing portion 9a of the elastic member 9 elastically contacts the inclined surface portion 8e of the movement member 8. That is, the first elastic contact portion 9b and the first inclined surface portion 8f elastically contact each other, and the second elastic contact portion 9c and the second inclined surface portion 8g elastically contact each other. In this way, the biasing portion 9a of the elastic member 9 elastically may contact the inclined surface portion 8e of the movement member 8, and thus, the contact portion 8t of the elastic member 9 and the contact portion 9e of the movement member 8 may be electrically connected to each other. Accordingly, the electronic component socket 300 is formed.

As shown in FIG. 17, the electronic component socket 300 may be disposed above the wiring substrate PB, the electrode terminal TM of the corresponding electronic device may be disposed on the upper portion of the socket, and thus, the socket may be used to electrically connect the wiring substrate PB and the electronic device. If the electronic component socket 300 is disposed on the wiring substrate PB, the contact portion 9e may contact the wiring of the wiring substrate PB which may be disposed below the opening portion 7b and may be electrically connected to the wiring. Accordingly, the wiring substrate PB and the electronic component socket 300 may be electrically connected to each other. In a state where the electrode terminal TM of the electronic device is not disposed above the electronic component socket 300, the movement member 8 may be positioned higher (Z1 direction side) than the state shown in FIG. 17, and the protrusion 8a may be supported to contact the end surface on the upper side of the concave portion 7a. If the electrode terminal TM of the electronic device is disposed above the electronic component socket 300, as shown in FIG. 17, the movement member 8 may be pressed downward (Z2 direction) by the electrode terminal TM of the electronic device, and thus, the biasing portions 9a of the elastic member 9 move downward while being bent. At this time, the biasing portions 9a slide along the inclined surface portions 8e while being bent, and thus, an electric connection between the conductive member 8d and the elastic member 9 may be maintained. In addition, the contact portion 8t of the conductive member 8d contacts the electrode terminal TM of the electronic component placed above the opening portion 7b, and thus, the electronic device and the electronic component socket 300 are electrically connected to each other. Accordingly, the wiring substrate PB and the electronic device may be electrically connected to each other via the electronic component socket 300. In addition, if the movement member 8 is pressed downward, the stopper portions 8s (refer to FIGS. 12A and 12B) may contact the upper surface of the shield body 7, and thus, the movement member 8 may be prevented from being inserted into the opening portion 7b more than necessary. Moreover, when the opening portion 7b is viewed from the lower surface side (Z2 direction side) (refer to FIGS. 15A and 15B), the stopper portions 8s contact the upper surface of the shield body 7 corresponding to the grooves 7e (refer to FIGS. 15A and 15B) on which the concave portions 7a are not provided in the opening shape of the opening portion 7b.

Electronic component socket 300 may include: the shield body 7 which forms the opening portion 7b and has conductivity; the movement member 8 which may include the conductive member 8d having the contact portion 8t capable of contacting the electrode terminal TM of the electronic component placed above the opening portion 7b; the elastic member 9 which may be electrically connectable to the wiring of the wiring substrate PB placed below the opening portion 7b and may include the biasing portion 9a having the biasing force and the base portion 9d fixing the biasing portion 9a, in which the movement member 8 is disposed to move vertically above the elastic member 9 in the opening portion 7b, and the biasing portion 9a elastically contacts the movement member 8, the movement member 8 may include the protrusion 8a protruding toward the shield body 7, the shield body 7 may include the concave portion 7a in which the protrusion 8a engages with the inner portion of the opening portion 7b, the conductive member 8d may include the inclined surface portion 8e which may be formed on the rear side of the protrusion 8a and extends so as to be close to the side, on which the protrusion 8a is provided, toward the lower portion, and the biasing portion 9a of the elastic member 9 elastically contacts the inclined surface portion 8e.

Accordingly, since the protrusion 8a is more easily formed compared to the cut-and-raised portion, a reduction in the size can be easily achieved. In addition, the conductive member 8d included in the movement member 8 may include the inclined surface portion 8e which may be formed on the rear side of the protrusion 8a and extends so as to be close to the side on which the protrusion 8a is provided toward the lower portion, and the biasing portion 9a of the elastic member 9 elastically contacts the inclined surface portion 8e from the lower portion. Accordingly, the movement member 8 may be biased upward by the elastic force of the biasing portion 9a, and may be biased to the direction in which the concave portion 7a is provided. That is, the protrusion 8a may be pressed to the concave portion 7a, and thus, engagement between the protrusion 8a and the concave portion 7a is securely performed. Accordingly, the electronic component socket, in which the removal preventing structure can be processed without being limited by the size of the conductive member 8d and desired removal prevention strength can be obtained, can be provided.

In the electronic component socket 300, the shield body 7 may be integrally formed and may be formed of a resin molded piece to which the metal plating is applied, and the concave portion 7a may be formed by molding.

Accordingly, the shield body 7 may be formed of the resin molded piece which is integrally formed, and thus, compared to when a plurality of parts are formed to be combined, assembly is easily performed. In addition, when metal plating is applied to the surface, it is not necessary to apply the metal plating to each of the plurality of parts, and thus, frequency of the plating can be decreased. In addition, there is an advantageous effect in that the formation of the concave portion 7a can be easily performed by a molding die.

Moreover, in the electronic component socket 300, the movement member 8 may include: the first protrusion 8b which may be provided on one side with respect to the first center line CL1 bisecting the opening end portion of the opening portion 7b in a plan view and on one side with respect to the second center line CL2 orthogonal to the first center line CL1, and protrudes toward the shield body 7; and the second protrusion 8c which may be provided on the other side with respect to the first center line CL1 and on the other side with respect to the second center line CL2, and may protrude in the direction opposite to the protrusion direction of the first protrusion 8b, the shield body 7 may include: the first concave portion 7c which may be provided on one side with respect to the first center line CL1 and on one side with respect to the second center line CL2, and may engage with the first protrusion 8b; and the second concave portion 7d which may be provided on the other side with respect to the first center line CL1 and on the other side with respect to the second center line CL2, and may engage with the second protrusion 8c, the inclined surface portion 8e of the conductive member 8d may include: the first inclined surface portion 8f which may be formed on the rear side of the first protrusion 8b and extends so as to be close to the side, on which the first protrusion 8b is provided, toward the lower portion; and the second inclined surface portion 8g which may be formed on the rear side of the second protrusion 8c and extends so as to be close to the side, on which the second protrusion 8c is provided, toward the lower portion, and the biasing portion 9a of the elastic member 9 includes the first elastic contact portion 9b which elastically contacts the first inclined surface portion 8f, and the second elastic contact portion 9c which elastically contacts the second inclined surface portion 8g.

Accordingly, the conductive member 8d included in the movement member 8 may include the inclined surface portion 8e which is formed on the rear side of the protrusion 8a and extends so as to be close to the side on which the protrusion 8a is provided toward the lower portion, and the biasing portion 9a of the elastic member 9 elastically contacts the inclined surface portion 8e from the lower portion. Therefore, the movement member 8 may be biased upward by the elastic force of the biasing portion 9a, and may be biased to the direction in which the concave portion 7a is provided. That is, the protrusion 8a may be pressed to the concave portion 7a, and thus, engagement between the protrusion 8a and the concave portion 7a is securely performed. Accordingly, the electronic component socket, in which the removal preventing structure can be processed without being limited by the size of the conductive member 8d and desired removal prevention strength can be obtained, can be provided.

In addition, in the electronic component socket 300, the shield body 7 may be formed of a metal plate, and the concave portion 7a may be formed by performing protrusion-processing on the metal plate.

Accordingly, since the shield body 7 may be formed of a metal plate, compared to the case where, for example, the shield body is formed of a plate-shaped member of a synthetic resin material and is subjected to the processing for providing conductivity, the shield body can be easily formed. Moreover, since the concave portion 7a may be formed by the protrusion-processing, compared to the cut-and-raised portion, there is an advantageous effect in that the reduction in the size can be easily achieved, damage does not easily occur, and yield can be improved.

In addition, in the electronic component socket 300, when the opening portion 7b is viewed from the lower surface side (Z2 direction side) (refer to FIGS. 15A and 15B), the stopper portion 8s contacts the upper surface of the shield body 7 corresponding to the groove 7e on which the concave portion 7a is not provided in the opening shape of the opening portion 7b. Accordingly, even when the protrusion amount of the stopper portion 8s from the opening shape of the opening portion 7b is small, the stopper portion 8s can contact the upper surface of the shield body 7, a pitch by which the opening portions 7b are disposed is decreased, and thus, the electrode terminal TM can correspond to an electronic component having a narrower pitch.

As in the above, the sockets for electronic component according to example embodiments of the present disclosure are specifically described. However, the present disclosure is not limited to the above-described embodiments, and various modifications can be performed within a scope which does not depart from the spirit of the present disclosure. For example, the following modifications can be performed, and the modifications are also included in a technical range of the present invention.

In various embodiments, the protrusion 1c having a convex shape is provided on the shield body 1, the concave portion 2k having a concave shape is provided on the movement member 2, and the protrusion 1c and the concave portion 2k engage with each other. Accordingly, the concave portion 2k moves in the direction approaching the protrusion 1c according to the movement of the movement member 2, and thus, the engagement between the protrusion 1c and the concave portion 2k is securely performed. However, a portion having a concave shape is provided on the shield body 1, a portion having a convex shape is provided on the movement member 2, and the portion having the concave shape provided on the shield body 1 and the portion having the convex shape provided on the movement member 2 may engage with each other.

Accordingly, the electronic component socket, in which the removal preventing structure can be processed without being limited by the size of the conductive member and desired removal prevention strength can be obtained, can be provided. In various embodiments, the shield body 1 has the structure in which the rectangular opening portions 1b are disposed to be arranged in a matrix shape in a plan view. However, the shield body may have a structure, in which the opening portions are deviated half for each row, instead of being disposed in matrix shape, such as a honeycomb structure.

In an example embodiment, the inclined surface portion 2c of the movement member 2 is biased by one biasing portion 3e which is disposed in the vicinity of the center of the base portion 3a. However, the inclined surface portion 2c of the movement member 2 may be biased in the same direction by a plurality of biasing portions 3e which are arranged in parallel. According to this configuration, even when the abutment position between the biasing portion 3e and the inclined surface portion 2c is slightly deviated, the movement member 2 is not easily inclined, and thus, the concave portion 2k can be more securely pressed to the protrusion 1c, and the falling-out of the movement member 2 can be more securely prevented.

In various embodiments, the concave portion 2k is formed as a through hole. However, the concave portion 2k may not be penetrated and may be formed in a concave shape. In addition, the concave shape may be a step shape which does not have right and left walls and is opened.

Also, the shield body 1 is formed of a metal plate. However, the shield body 1 may be integrally formed and be formed of a resin molded piece to which metal plating is applied, and the protrusion 1c may be formed by molding. The shield body 1 is formed of the resin molded piece which is integrally formed, and thus, compared to when a plurality of parts are formed to be combined, assembly is easily performed. In addition, when metal plating is applied to the surface, it is not necessary to apply the metal plating to each of the plurality of parts, and thus, frequency of the plating can be decreased. Moreover, the formation of the protrusion 1c can be easily performed by a molding die. In addition, it is not necessary to combine a plurality of parts, and thus, a disadvantage such as damage due to an assembly mistake does not easily occur.

It should be understood by those skilled in the art that various modifications, combinations, sub-combinations and alterations may occur depending on design requirements and other factors insofar as they are within the scope of the appended claims of the equivalents thereof.

Accordingly, the embodiments of the present inventions are not to be limited in scope by the specific embodiments described herein. Further, although some of the embodiments of the present disclosure have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. An electronic component socket, comprising:
a shield body configured to form an opening portion and have conductivity;
a movement member which includes a conductive member having a contact portion capable of contacting an electrode terminal of an electronic component placed above the opening portion; and
an elastic member which is configured to be electrically connectable to a wiring of a wiring substrate placed below the opening portion and includes a biasing portion having a biasing force and a base portion fixing the biasing portion,
wherein the movement member is disposed to move vertically above the elastic member in the opening portion, and the biasing portion elastically contacts the movement member,
wherein the shield body includes a protrusion protruding toward a center of the opening portion in the opening portion,
wherein the movement member includes a concave portion which engages with the protrusion,
wherein the conductive member includes an inclined surface portion which is formed on an opposite side of the concave portion and extends so as to be close to a side, on which the concave portion is provided, as extending toward a lower side, and
wherein the biasing portion of the elastic member elastically contacts the inclined surface portion.

2. The electronic component socket according to claim 1,
wherein the shield body is formed of a metal plate, and the protrusion is formed by protrusion-processing the metal plate.

3. The electronic component socket according to claim 1,
wherein the shield body is integrally formed and is formed of a resin molded piece to which metal plating is applied, and the protrusion is formed by molding.

4. The electronic component socket according to claim 1,
wherein the shield body includes: a first protrusion which is provided on one side with respect to a first center line bisecting an opening end portion of the opening portion in a plan view and on one side with respect to a second center line orthogonal to the first center line, and protrudes in a center direction of the opening portion; and a second protrusion which is provided on the other side with respect to the first center line and on the other side with respect to the second center line, and protrudes in a direction opposite to the protrusion direction of the first protrusion,
wherein the movement member includes: a first concave portion which is provided on one side with respect to the first center line and on one side with respect to the second center line, and engages with the first protrusion; and a second concave portion which is provided on the other side with respect to the first center line and on the other side with respect to the second center line, and engages with the second protrusion,
wherein the inclined surface portion of the conductive member includes: a first inclined surface portion which is formed on a rear side of the first concave portion and extends so as to be close to the side, on which the first concave portion is provided, toward a lower side; and a second inclined surface portion which is formed on a rear side of the second concave portion and extends so as to be close to the side, on which the second concave portion is provided, toward a lower side, and
wherein the biasing portion of the elastic member includes a first elastic contact portion which elastically contacts the first inclined surface portion, and a second elastic contact portion which elastically contacts the second inclined surface portion.

5. An electronic component socket, comprising:
a shield body configured to form an opening portion and have conductivity;
a movement member which includes a conductive member having a contact portion capable of contacting an electrode terminal of an electronic component placed above the opening portion; and
an elastic member which is configured to be electrically connectable to a wiring of a wiring substrate placed below the opening portion and includes a biasing portion having a biasing force and a base portion fixing the biasing portion,
wherein the movement member is disposed to move vertically above the elastic member in the opening portion, and the biasing portion elastically contacts the movement member,
wherein the movement member includes a protrusion protruding toward the shield body,
wherein the shield body includes a concave portion which engages with the protrusion in the opening portion,
wherein the conductive member includes an inclined surface portion which is formed on a rear side of the protrusion and extends so as to be close to a side, on which the protrusion is provided, toward a lower side, and
wherein the biasing portion of the elastic member elastically contacts the inclined surface portion.

6. The electronic component socket according to claim 5,
wherein the shield body is integrally formed and is formed of a resin molded piece to which metal plating is applied, and the concave portion is formed by molding.

7. The electronic component socket according to claim 5,
wherein the shield body is formed of a metal plate, and the concave portion is formed by protrusion-processing the metal plate.

8. The electronic component socket according to claim 5,
wherein the movement member includes: a first protrusion which is provided on one side with respect to a first center line bisecting an opening end portion of the opening portion in a plan view and on one side with respect to a second center line orthogonal to the first center line, and protrudes toward the shield body; and a second protrusion which is provided on the other side with respect to the first center line and on the other side with respect to the second center line, and protrudes in a direction opposite to the protrusion direction of the first protrusion,
wherein the shield body includes: a first concave portion which is provided on one side with respect to the first center line and on one side with respect to the second center line, and engages with the first protrusion; and a second concave portion which is provided on the other side with respect to the first center line and on the other side with respect to the second center line, and engages with the second protrusion,
wherein the inclined surface portion of the conductive member includes: a first inclined surface portion which is formed on a rear side of the first protrusion and extends so as to be close to the side, on which the first protrusion is provided, toward a lower side; and a second inclined surface portion which is formed on a rear side of the second protrusion and extends so as to be close to the side, on which the second protrusion is provided, toward a lower side, and
wherein the biasing portion of the elastic member includes a first elastic contact portion which elastically contacts the first inclined surface portion, and a second elastic contact portion which elastically contacts the second inclined surface portion.
